(19) United States
(12) Patent Application Publication
(10) Pub. No.: US 2019/0206012 A1
(43) Pub. Date: Jul. 4, 2019

(54) ONLINE MARKETING LOTTERY SCRATCH-OFF SYSTEM

(71) Applicants: William Granich, Woodland Hills, CA (US); Edmond A. DeFrank, Northridge, CA (US); Nicolas DeFrank, Northridge, CA (US); Antonio DeFrank, Northridge, CA (US); Allen Mark Jones, Imperial Beach, CA (US)

(72) Inventors: William Granich, Woodland Hills, CA (US); Edmond A. DeFrank, Northridge, CA (US); Nicolas DeFrank, Northridge, CA (US); Antonio DeFrank, Northridge, CA (US); Allen Mark Jones, Imperial Beach, CA (US)

(21) Appl. No.: 15/859,575

(22) Filed: Dec. 31, 2017

(51) Int. Cl. G06Q 50/34; G06Q 30/02; G07F 17/32

(52) U.S. Cl. CPC G06Q 50/34; G07F 17/329; G06Q 30/0261; G06Q 30/0277

(57) ABSTRACT

The embodiments disclose a method including creating an online marketing lottery scratch-off method for at least one marketing opportunity for companies, creating an online marketing lottery scratch-off website, displaying online virtual scratch-off tickets to offer prizes to a user for gathering user marketing information, recording user marketing information in an online marketing lottery scratch-off website database, and analyzing online marketing lottery scratch-off method database customer data collected for targeted purposes.

### BACKGROUND

Lotteries and lottery scratch-offs offer monetary prizes. They have low odds of winning which can discourage players for buying into the lottery. Lottery scratch-offs currently do not offer any player interaction or any real-time experiences that reward the player beyond their limited chance of winning. Lotteries and lottery scratch-off organizations are stand alone and other than contributing part of the ticket sales to education are not aligned with private companies or other charitable organization. This limited business outlook and player experience decreases the potential benefits to all concerned in the lottery market place.

### BRIEF DESCRIPTION OF THE DRAWINGS

FIG. 1 shows a block diagram of an overview of an online marketing lottery scratch-off method of one embodiment.

FIG. 2 shows a block diagram of an overview flow chart of player/user registration of one embodiment.

FIG. 3 shows a block diagram of an overview flow chart of synergistic relationships with companies of one embodiment.

FIG. 4 shows a block diagram of an overview flow chart of accurate tracking and restrictions of one embodiment.

FIG. 5 shows a block diagram of an overview flow chart of cross identifying information of one embodiment.

FIG. 6 shows a block diagram of an overview flow chart of mobile application GPS recognition of one embodiment.

FIG. 7 shows a block diagram of an overview flow chart of method features enhance the user's experience of one embodiment.

FIG. 8 shows for illustrative purposes only an example of a scratch-off downloaded to a wireless touch screen device of one embodiment.

FIG. 9 shows for illustrative purposes only an example of user recognition authentication features of one embodiment.

FIG. 10 shows for illustrative purposes only an example of scratching can be done by a finger swipe of one embodiment.

FIG. 11A shows for illustrative purposes only an example of an identification code verification to scratch-off of one embodiment.

FIG. 11B shows for illustrative purposes only an example of an eye scan identifier verification to scratch-off of one embodiment.

FIG. 11C shows for illustrative purposes only an example of a voice recognition password verification to scratch-off of one embodiment.

FIG. 12 shows for illustrative purposes only an example of scratching by eye position motion detection of one embodiment.

FIG. 13 shows for illustrative purposes only an example of shaking device to scratch-off prize coverings of one embodiment.

FIG. 14 shows a block diagram of an overview of reporting winning prizes of one embodiment.

FIG. 15 shows a block diagram of an overview of a user smart phone sign in of one embodiment.

FIG. 16 shows for illustrative purposes only an example of marketing opportunity for companies of one embodiment.

FIG. 17 shows for illustrative purposes only an example of other prizes of one embodiment.

FIG. 18A shows for illustrative purposes only an example of pickup truck online marketing lottery scratch-off prizes of one embodiment.

FIG. 18B shows for illustrative purposes only an example of car online marketing lottery scratch-off prizes of one embodiment.

FIG. 18C shows for illustrative purposes only an example of boat online marketing lottery scratch-off prizes of one embodiment.

FIG. 18D shows for illustrative purposes only an example of cruise vacation online marketing lottery scratch-off prizes of one embodiment.

FIG. 18E shows for illustrative purposes only an example of time-share vacation online marketing lottery scratch-off prizes of one embodiment.

FIG. 19 shows a block diagram of an overview of online marketing lottery scratch-off method database customer data collected for targeted purposes of one embodiment.

FIG. 20 shows a block diagram of an overview of a group lotto method of one embodiment.

FIG. 21 shows a block diagram of an overview of a group lotto website network of one embodiment.

FIG. 22A shows for illustrative purposes only an example of a group lotto secure sign-in process of one embodiment.

FIG. 22B shows for illustrative purposes only an example of a group lotto user/player interactive processes of one embodiment.

FIG. 22C shows for illustrative purposes only an example of a group lotto lottery number selection process of one embodiment.

FIG. 23 shows for illustrative purposes only an example of a group lotto lottery ticket process of one embodiment.

FIG. 24 shows for illustrative purposes only an example of an automatic lottery ticket pick form process of one embodiment.

FIG. 25 shows for illustrative purposes only an example of a group lotto network lottery ticket retailer module of one embodiment.

FIG. 26 shows for illustrative purposes only an example of a group lotto network scratch-off ticket retailer module of one embodiment.

FIG. 27 shows for illustrative purposes only an example of a group lotto network lottery ticket retailer for an out of town resident process of one embodiment.

FIG. 28 shows for illustrative purposes only an example of a group lotto network lottery ticket and scratch-off retailer for a disabled resident module of one embodiment.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the embodiments.

It should be noted that the descriptions that follow, for example, in terms of online marketing lottery scratch-off method is described for illustrative purposes and the underlying method can apply to any number and multiple type's lottery and game of chance. In one embodiment of the embodiments, the online marketing lottery scratch-off can be configured using digital scratch off tickets. The online marketing lottery scratch-off method can be configured to include monetary prizes and can be configured to include consumer product, services and other non-monetary types of prizes using the embodiments.

### General Overview

### Online Marketing Lottery Scratch-Off Method

The embodiments include expanding the type of prizes, numbers of prizes, increased odds of winning through offering expanded prize pools that include along with monetary prizes, non-monetary prizes in a supplementary or substitute basis. The online marketing lottery scratch-off method incorporates synergistic relationships with companies to provide the companies the opportunity to market their products and service in exchange for prize products and services and reduced advertising rates. The addition of prize products and services will increase the number of prizes available to be won by players thus increasing the odds of winning of one embodiment.

In the descriptions that follow the term “scratch-off”, “online marketing lottery scratch-off”, “online lottery scratch-off” and “digital scratch off ticket” are interchangeably used to describe an apparatus that has the meaning of a virtual digital game card (ticket) display where multiple prizes are concealed under a covering mask that can be virtually scratched-off to reveal the prize concealed underneath of one embodiment.

The online marketing lottery scratch-off method includes a digital programmable virtual lottery scratch-off method, at least one digital programmable application interacting with the digital programmable virtual lottery scratch-off method, and at least one player/user method interface using the at least one digital programmable application to communicate between the digital programmable virtual lottery scratch-off method and at least one player/user wireless touch screen device on which at least one digital programmable application has been installed of one embodiment.

The player can also earn points or credits by log-in observation of sponsored ads and commercials, participation in on-line lottery scratch-off sponsoring company's product surveys and inputting online proof of purchase data like “cereal box tops” to “tooth paste” boxes of lottery scratch-off sponsoring companies. The player they will be able to get further credit by typing in purchased products serial # info. This provides lottery scratch-off sponsoring companies with tangible proof of the effectiveness of the online marketing lottery scratch-off method advertising. The online marketing lottery scratch-off method gains by the ability to rely less on the number of players' dollars to increase the pot totals. Better odds of winning will produce many more winners. As people have the chance to win more often, there will be more players making the advertising yield to the lottery scratch-off sponsoring companies reach a greater market for the same cost of one embodiment.

Companies with products enhance and supply number of prizes, products, services and more things of value like vacations and travel. Will stimulate the entire lottery experience and allow for many more winners and betters odds of winning of one embodiment.

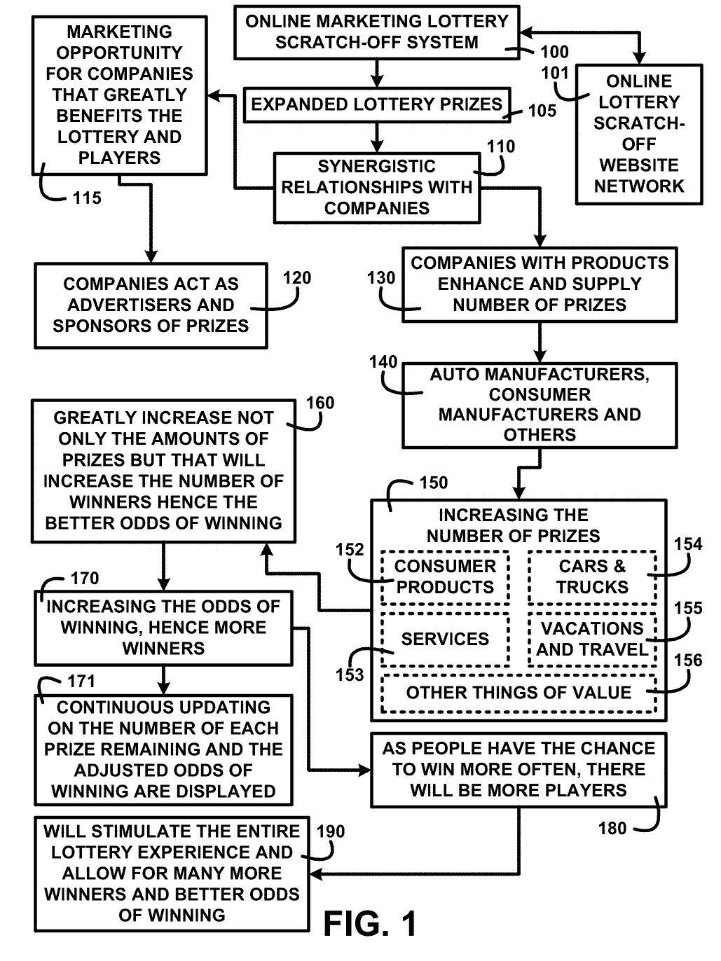

FIG. 1 shows a block diagram of an overview of an online marketing lottery scratch-off method of one embodiment. FIG. 1 shows an online marketing lottery scratch-off method 100 including an online lottery scratch-off website network 101 that provides expanded lottery prizes 105. Expanded lottery prizes 105 are achieved using synergistic relationships with companies 110. This provides additional marketing opportunity for companies that greatly benefit the lottery and players 115. Companies act as advertisers and sponsors of prizes 120. Companies with products enhance and supply number of prizes 130 including for example auto manufacturers, consumer manufacturers, et al. 140. The player/user benefits with increasing the number of prizes 150 including consumer products 152, services 153, cars & trucks 154, vacations and travel 155 and other things of value 156 including cash and non-cash prizes.

The synergistic relationships with companies 110 greatly increase not only the amounts of prizes but that will increase the number of winners hence the better odds of winning 160, increasing the odds of winning, hence more winners 170. To earn player/user trust the online lottery scratch-off website network 101 using digital processers preforms continuous updating on the number of each prize remaining and the adjusted odds of winning are displayed 171 using the online lottery scratch-off website network 101. As people have the chance to win more often, there will be more players 180. The online marketing lottery scratch-off method 100 will stimulate the entire lottery experience and allow for many more winners and betters odds of winning 190 of one embodiment.

### Detailed Description

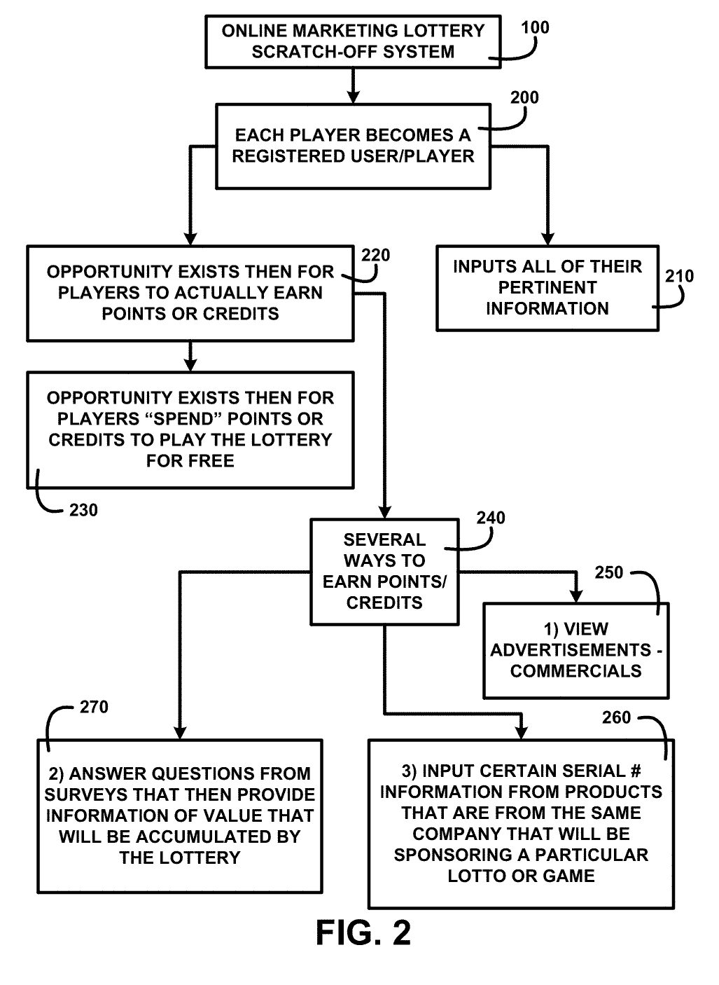

FIG. 2 shows a block diagram of an overview flow chart of player/user registration of one embodiment. FIG. 2 shows in one embodiment an application of the online marketing lottery scratch-off method 100 includes for example where each player becomes a registered user/player 200 and inputs all of their pertinent information 210. The opportunity exists then for players to actually earn points or credits 220. The opportunity exists then for players to actually earn points or credits 220 is used for increasing the number of prizes, increasing the odds of winning, hence more winners, and providing a synergistic marketing opportunity for companies that greatly benefits the lottery and players of one embodiment. The opportunity exists then for players “spend” points or credits to play the lottery for free 230. In the online marketing lottery scratch-off method several ways to earn points/credits 240 including view advertisements—commercials 250, answer questions from surveys that then provide information of value that will be accumulated by the lottery 270, and input certain serial # information from products that are from the same company that will be sponsoring a particular lotto or game 260 of one embodiment.

### Synergistic Relationships with Companies

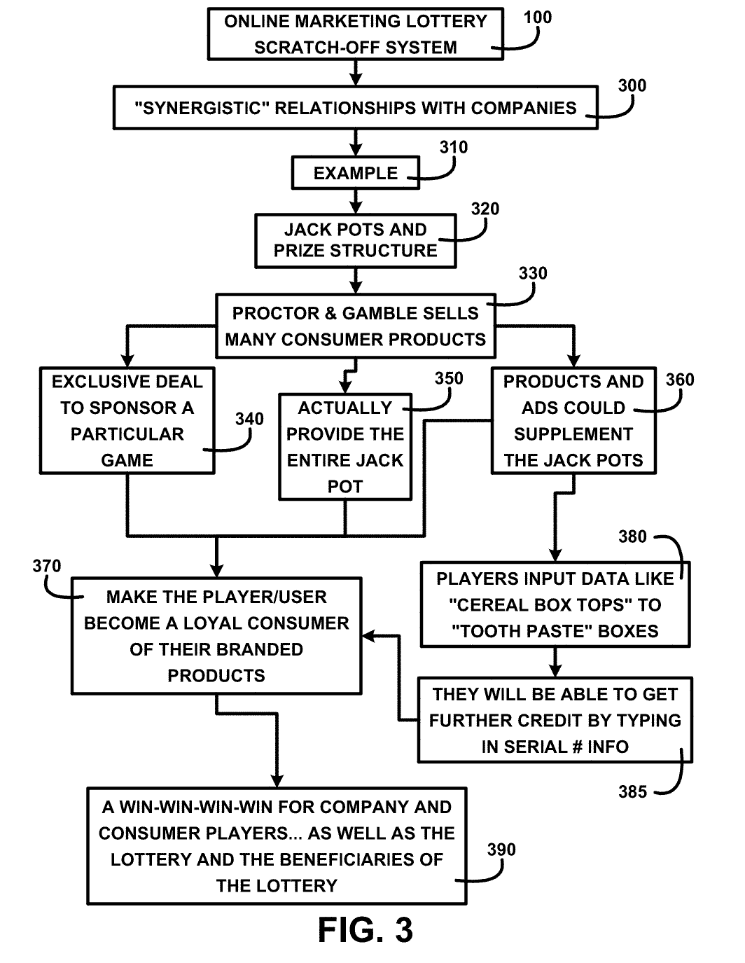

FIG. 3 shows a block diagram of an overview flow chart of synergistic relationships with companies of one embodiment. FIG. 3 shows in one embodiment synergistic relationships with companies in the online marketing lottery scratch-off method 100. Synergistic relationships with companies 300 for example 310 companies providing jack pots and prize structure 320. The online marketing lottery scratch-off method will establish business relationships with companies, as previously explained with cars & trucks from auto manufacturers, consumer manufacturers, et al. It will be progressing the lottery industry into “synergistic” relationships with companies as they would greatly increase not only the amounts of prizes but that will increase the number of winners hence the better odds of winning. As people have the chance to win more often, there will be more players. Their products and ads could supplement the jackpots 360 or actually provide the entire jackpot 350 depending on the structure. But each game will obviously be structured so as to benefit all of one embodiment.

For example proctor & gamble sells many consumer products 330 and could achieve a synergistic relationship by doing an exclusive deal to sponsor a particular game 340. Several ways to earn credits to play their lotto games for free. In one embodiment there is a place player's input data like “cereal box tops” to “tooth paste” boxes 380 that make the player/user become a loyal consumer of their branded products 370 as they will be able to get further credit by typing in serial # info 385. A win-win-win-win for company and consumer players . . . as well as the lottery and the beneficiaries of the lottery 390 of one embodiment.

### Accurate Tracking and Restrictions

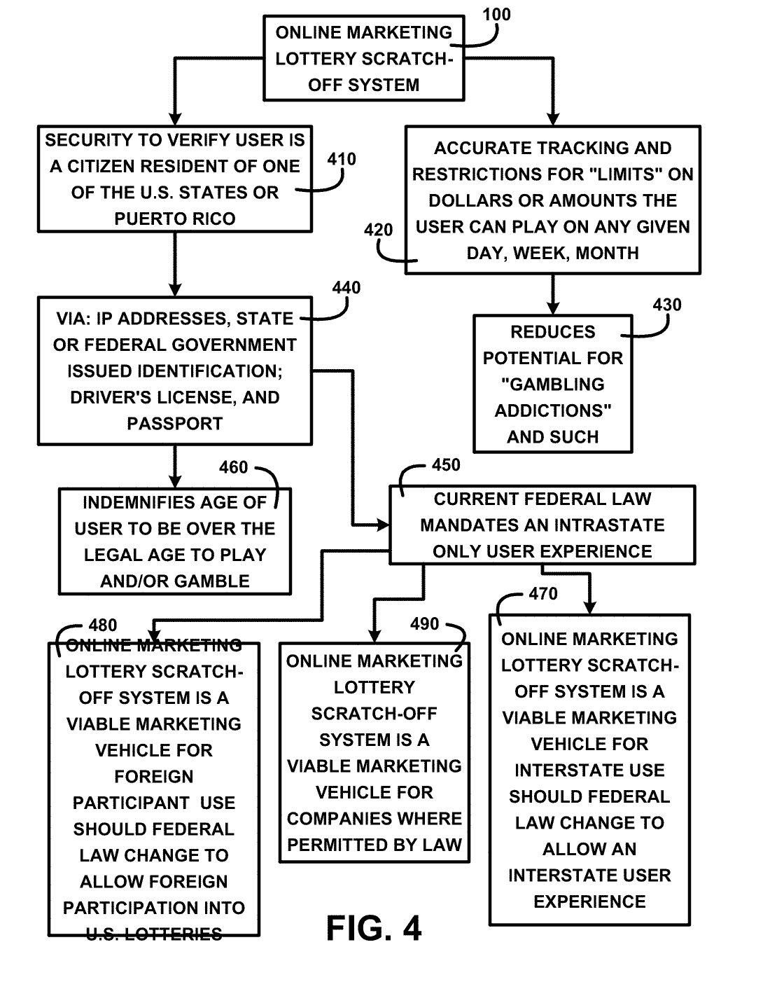

FIG. 4 shows for illustrative purposes only an example of accurate tracking and restrictions of one embodiment. FIG. 4 shows in one embodiment accurate tracking and restrictions in the online marketing lottery scratch-off method 100. Accurate tracking and restrictions for “limits” on dollars or amounts the user can play on any given day, week, month 420. This reduces potential the concern for “gambling addictions” and such 430. The method includes security to verify user is a citizen resident of one of the U.S. states or Puerto Rico 410 via: IP addresses, state or federal government issued identification; driver's license, and passport 440. In this embodiment the method indemnifies age of user to be over the legal age to play and/or gamble 460. The method is also used for compliance where current federal law mandates an intrastate only user experience 450. Online marketing lottery scratch-off method is a viable marketing vehicle for interstate use should federal law change to allow an interstate user experience 470. Online marketing lottery scratch-off method is a viable marketing vehicle for foreign participant use should federal law change to allow foreign participation into U.S. Lotteries 480. Online marketing lottery scratch-off method is a viable marketing vehicle for companies where permitted by law 490 of one embodiment.

### Cross Identifying Information

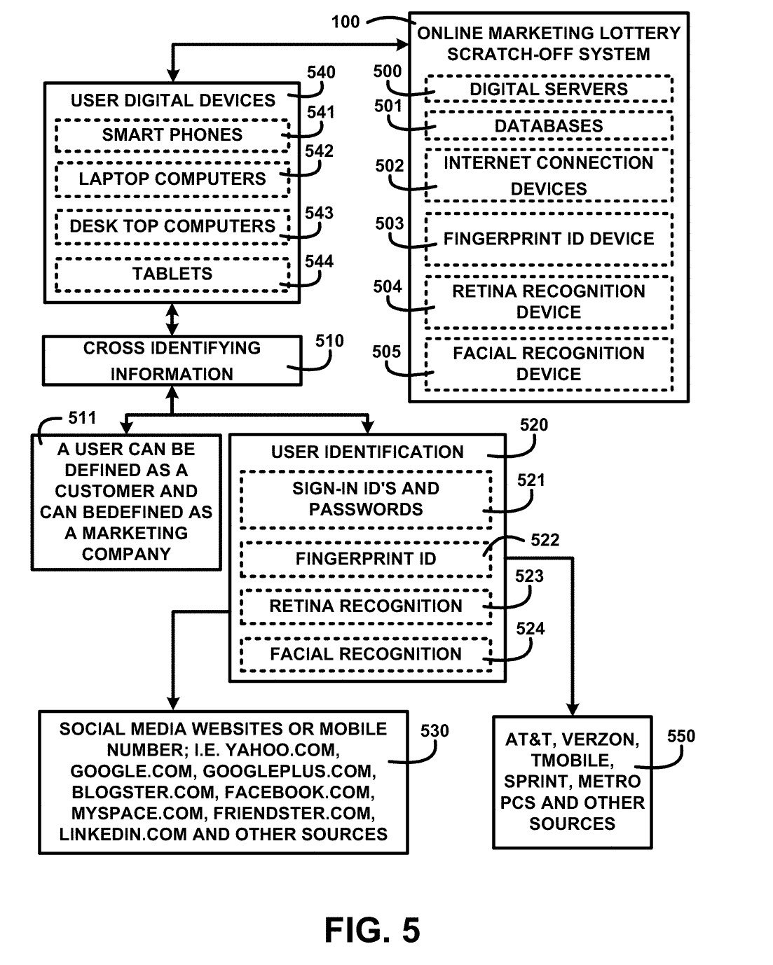

FIG. 5 shows for illustrative purposes only an example of cross identifying information of one embodiment. FIG. 5 shows in one embodiment cross identifying information used in the online marketing lottery scratch-off method 100. The online marketing lottery scratch-off method 100 includes a network structure including at least one digital server 500, at least one database 501, at least one internet connection device 502, at least one fingerprint ID device 503, at least one retina recognition device 504, and at least one facial recognition device 505. The online marketing lottery scratch-off method 100 network can be accessed using user digital devices 540 including smart phones 541, laptop computers 542, desk top computers 543 and tablets 544 of one embodiment.

The online marketing lottery scratch-off method 100 network access uses cross identifying information 510 to identify a user. A user can be defined as a customer and can be defined as a marketing company 511. The cross identifying information 510 includes a user identification 520 including using sign-in ID's and passwords 521, fingerprint ID 522, retina recognition 523, facial recognition 524 and voice recognition. Cross identifying information 510 includes checks on social media websites or mobile number; i.e. yahoo.com, google.com, googleplus.com, blogster.com, facebook.com, myspace.com, friendster.com, linkedin.com, and other sources 530 and AT&T, Verizon, T*mobile, sprint, Metro PCS, and other sources 550 of one embodiment.

### Mobile Application GPS Recognition

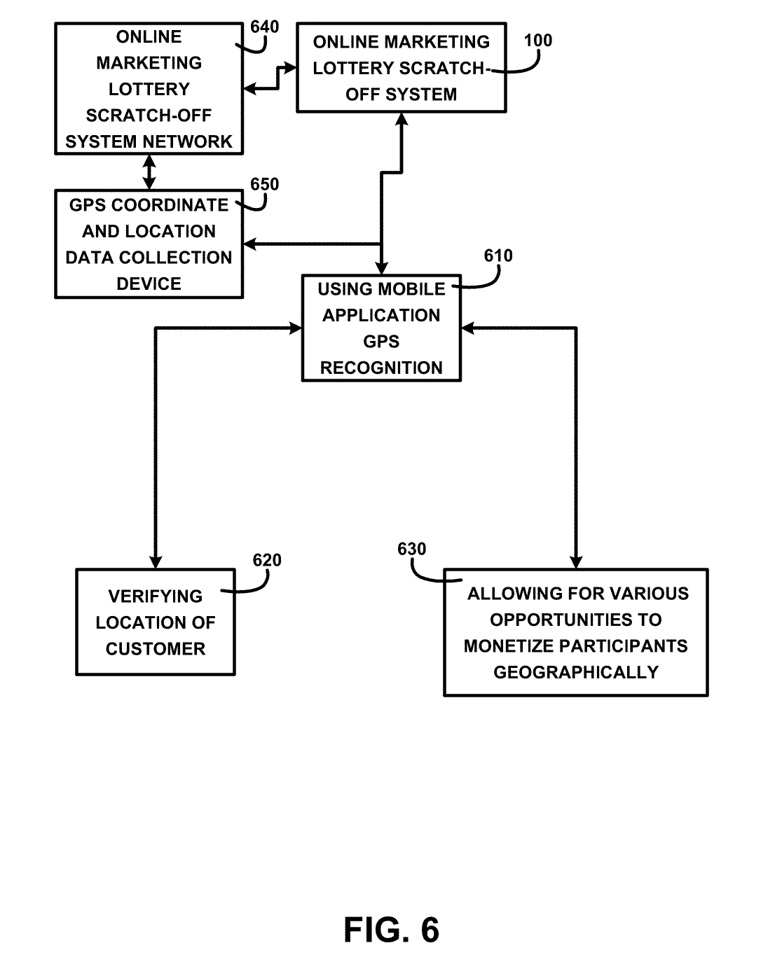

FIG. 6 shows for illustrative purposes only an example of mobile application GPS recognition of one embodiment. FIG. 6 shows in one embodiment mobile application GPS recognition used in the online marketing lottery scratch-off method 100. The online marketing lottery scratch-off method 100 processes a request for a user GPS location through the online marketing lottery scratch-off method network 640 to the user digital devices 540 of FIG. 5. The online marketing lottery scratch-off method network 640 further processes a user GPS location using a GPS coordinate and location data collection device 650. Mobile application GPS recognition 610 is used to verifying location of customer 620 to allow for various opportunities to monetize participants geographically 630. It also is used to check compliance with intra-state environments of one embodiment.

### Method Features Will Enhance the User's Experience

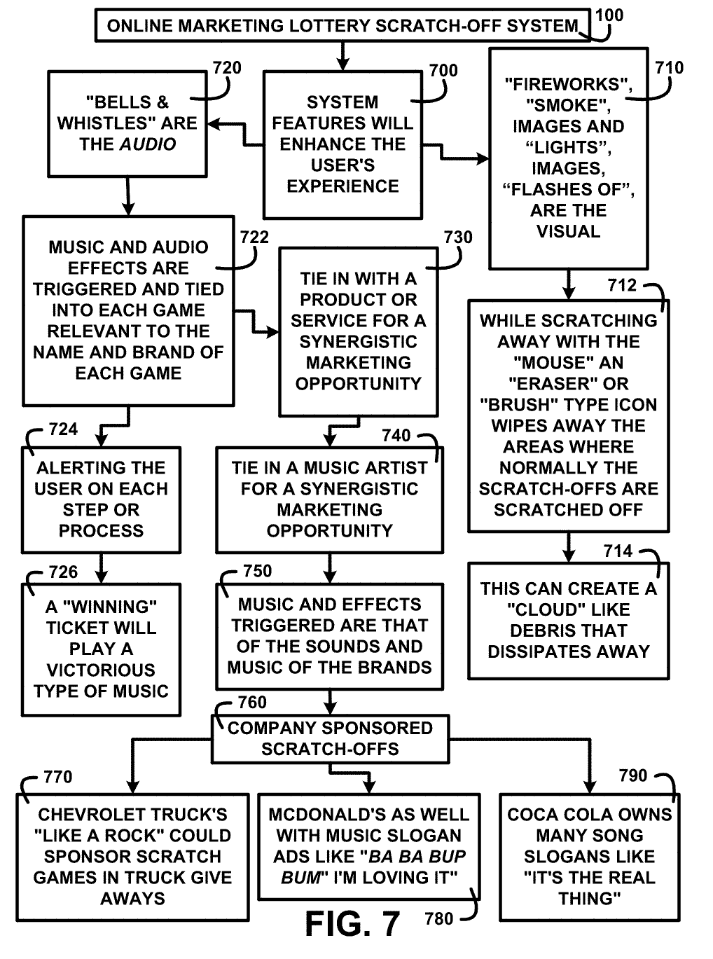

FIG. 7 shows for illustrative purposes only an example of method features enhance the user's experience of one embodiment. FIG. 7 shows in one embodiment method features will enhance the user's experience using the online marketing lottery scratch-off method 100. In one embodiment method features will enhance the user's experience 700 using fireworks, “smoke”, images and “lights”, images, “flashes of”, are the visual 710 while scratching away with the “mouse” an “eraser” or “brush” type icon wipes away the areas where normally the scratch-offs are scratched off 712. Visual features can be used where this can create a “cloud” like debris that dissipates away 714. In another embodiment sounds including bells & whistles are the audio 720 enhancements. Music and audio effects are triggered and tied into each game relevant to the name and brand of each game 722 alerting the user on each step or process 724 for example a “winning” ticket will play a victorious type of music 726. These features are used to tie in with a product or service for a synergistic marketing opportunity 730. Companies have many advertisement campaigns that have “jingles” and/or song snippets that could play as audio effects and bells and whistles. Company sponsored scratch-offs for example where by music and effects are triggered including the sounds and music of the brands. This includes a feature to tie in a music artist for a synergistic marketing opportunity 740. Music and effects triggered are that of the sounds and music of the brands 750 of company sponsored scratch-offs 760. For example Chevrolet trucks “like a rock” could sponsor scratch games in truck giveaways 770. McDonald's as well with music slogan ads like “ba ba bup bum I'm loving it” 780 and Coca Cola owns many song slogans like “it's the real thing” 790 of one embodiment.

Another functionality will be; the ability for companies of products & services to put up some of the prizes or money whereby their benefit is in a partnership manner. The lottery then will rely less on the number of players' dollars to increase the pot total but will also benefit by a company putting up their products or services . . . Hence yielding even more dollars and/or prizes for more winners. The more winners and opportunities the more players and the result is a net higher profit value for the lottery and its beneficiaries, and everybody wins. I.e. In the state of California the beneficiary group is the state's school and education method. In Pennsylvania the main beneficiary is; “the AAAS administer senior centers across the state and provide a wide variety of services, including; assessments and program referral, home-delivered meal, health insurance counseling, ombudsman services and legal assistance, protective services, transportation” of one embodiment.

The online marketing lottery scratch-off method can offer specialized play through various domains including for example Scratch4cars.com and Scratchforcars.com. Event tie-ins like Scratch4tickets.com Scratchfortickets.com customized to the entertainment and movie industry that consistently spend millions of dollars marketing, advertising and publicity for each film release. Movie studios will be able to provide free tickets to new movie releases. These will be the lower value scratch-off winners when for example the user doesn't win a new car or truck. The entertainment company will love to contribute because in most cases a family has more than 2 people, so even if they “win” 2 tickets they will bring the rest of the family to purchase tickets. Travel and vacation tie-ins with domains that explain this like; Scratch4vacations.com, Scratchforvacations.com, Click4prizes.com of one embodiment.

The benefit is to everyone, the more cash and prizes the more winners and happy players, more products and services are sold and of course the more money raised for the lottery and all of the lottery's beneficiaries. The overall macro perspective of how this will affect the lotteries and more importantly the “instant winning” games like scratch-offs. When more companies of products & services put up partnership deals, much in the same fashion as the “coupon & groupon” equivalent world, the overall net result will be a higher number or percentage of winners per scratch or draw. Using the online marketing lottery scratch-off method it could safely computed and advertised that the chances of winning some prize is for example as small as in say “1 in 4”. More people will be attracted to play, yielding recording revenues and benefits to all of one embodiment.

Online marketing lottery scratch-off method mobile GPS operation that know where you're playing from and have the capability of offering deals from vendors in that area. This maximizes any potential opportunity for a sale for that vendor since the player is playing in their general area of one embodiment.

More graphic type capabilities can for example include a scratch-off cover image on each section that morphs when scratched to an scratch-off sponsoring company ad image in the same space building suspense for example for 10 seconds and then reveals the prize or number leading to a win. The advanced graphic capabilities will provide additional advertising, player experience and excitement in the category of “fireworks” of one embodiment.

The idea of a “scratch ticket” when selected amongst a list or group of others, that pops out and twirls around or “dances” to the beat of a song. This could be achieved in software such as “java” or an equivalent of one embodiment.

The ability for the purchaser to buy a block of tickets and distribute them to multiple friends or family via “email addresses” or any social media network. The ability that a purchaser to be able to play as a part of a “group” of people which would eliminate any controversy that leads to legal actions of one embodiment.

Many people buy lottery tickets in groups of people, like a group of friends or co-workers. This ability will eliminate the potential for legal actions should any particular player be excluded from any particular drawing or bulk purchase. This would register the identities, either via names, or email addresses or social network identities, therefore assuring their inclusion in the overall purchase of the tickets hence guaranteeing their participation. This functionality and application can eliminate the potential for disagreements or legal actions of one embodiment.

### User Qualifying Parameters

Qualifying the users using several different parameters. These types of user qualifying parameters would allow the website to collect relevant data and information from each user to better provide more targeted games and games with sponsors seeking to reach that specific audience of one embodiment.

For example one user will like “trucks” and outdoor things. Another user could be identified as a “female” that is more interested in beauty and cosmetic product types of goods and services. Another could be a younger user with interests pertaining to things of interest relevant geared towards the companies that sell, market and advertise products more suited to them of one embodiment.

Online scratch-offs with ties to financial oriented companies for example, users that open an account with their lottery and originally fund the account with money, could actually be funding an account that is tied into the lottery company with a partner company like a bank or brokerage company. What this does is introduces the new user/player to the financial institution by then having a new account or “relationship” with this financial company. This opens up the possibilities for further interest in the goods or services that this company or institution offers. This is not limited to banks and brokerages. This could also be with “retail” companies via a “debit” card with what is usually associated with visa, MasterCard, Discover Card or American Express and the up and coming new PayPal which is making inroads to relationships with various new retailers and outlets. What comes to mind with most potent potential currently would be a “PayPal” partnership, for example this would ultimately increase PayPal's user/customer base and overall awareness of their offerings and abilities. With this, PayPal could more effectively make inroads to more retailers since they could reference a broader user base which ultimately is what's attractive to any retailer or goods and services seller that PayPal is trying to establish a new account with of one embodiment.

The online marketing lottery scratch-off method can make for an explosion and advancement for many different products and services companies as well as increase the number of players interested to play lottery since the chances of winning anything will ultimately be greater because everyone benefits including the lottery entities and their beneficiaries of one embodiment.

The user players like that the overall percentages to win anything dramatically increases with the participations of products and services companies. The products & services companies like their benefits of more customers and awareness hence creating more opportunities on several different platforms for them to monetize the increases. The lottery entities love this whole thing because it ultimately generates more revenues and profits for them. The “beneficiaries” to the lottery profits benefit greatly with hugely increased revenues. It becomes a win-win-win-win of one embodiment.

### Scratch-Off Downloaded to a Wireless Touch Screen Device

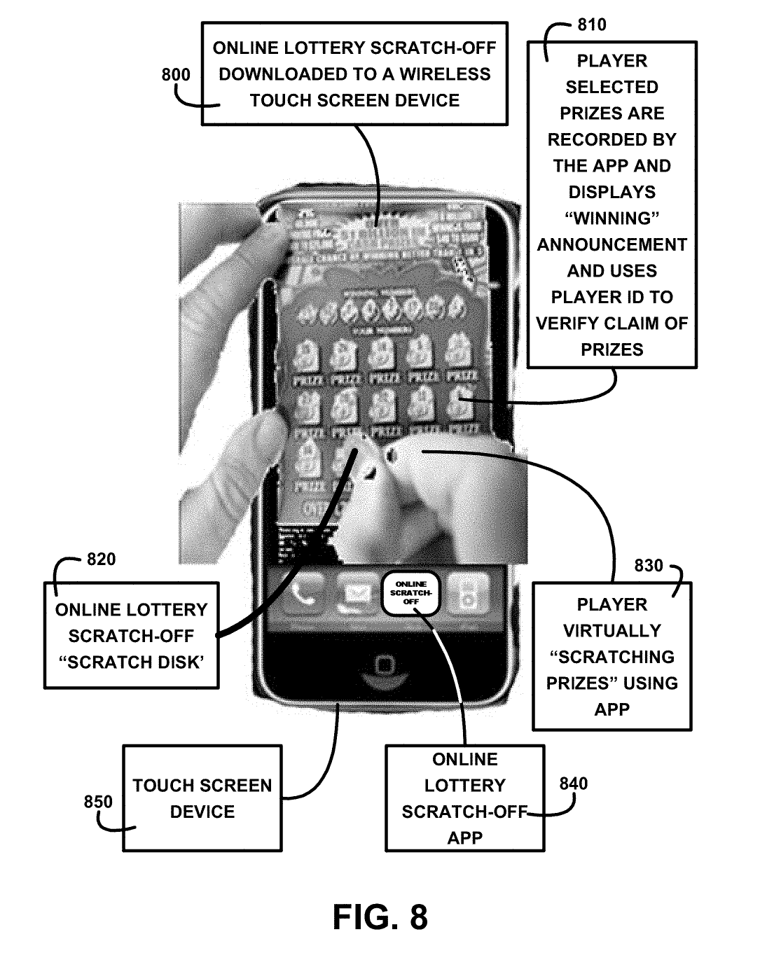

FIG. 8 shows for illustrative purposes only an example of a scratch-off downloaded to a wireless touch screen device of one embodiment. FIG. 8 shows in one embodiment scratch-off downloaded to a wireless touch screen device. The user logins into the application and the online marketing lottery scratch-off method processes an online lottery scratch-off downloaded to a wireless touch screen device 800. Player selected prizes are recorded by the app and displays “winning” announcement and uses player ID to verify claim of prizes 810. The user can use in one embodiment an online lottery scratch-off “scratch disk” 820 where the player virtually “scratching prizes” using app 830. The online lottery scratch-off app 840 is downloaded into a touch screen device 850 by the user from the online lottery scratch-off website or other internet sites or through a purchase of the application through a retailer of one embodiment.

### User Recognition Authentication Features

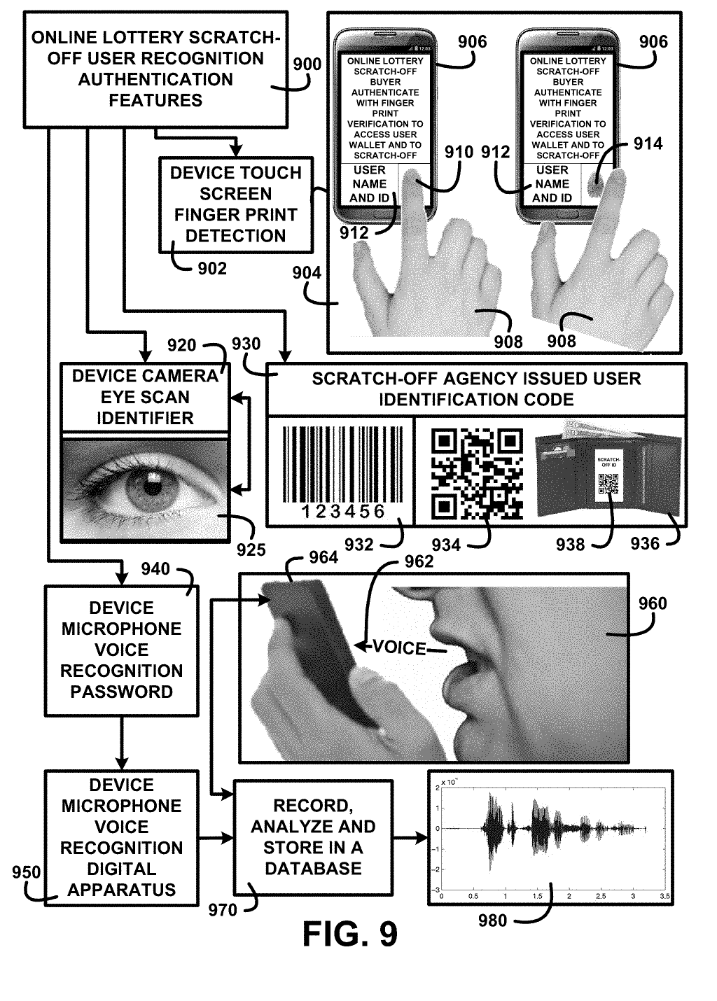

FIG. 9 shows for illustrative purposes only an example of user recognition authentication features of one embodiment. FIG. 9 shows in one embodiment user recognition authentication features. The online lottery scratch-off user recognition authentication features 900 includes in one embodiment a device touch screen finger print detection 902 method. A user entering finger print 904 includes the user name and ID 912 inputted by the user. The device touch screen finger print detection 902 method includes in one embodiment utilization of a device 906 including touch screen and pressure/temperature features. The device will record, analyze and store in a database the user finger print 914 and compare the record finger print with any user hand and finger 908 that seeks authentication to be recognized of one embodiment.

The online lottery scratch-off user recognition authentication features 900 include in one embodiment a device camera eye scan identifier 920. The device camera eye scan identifier 920 captures, records, analyzes and stores in a database a user eye camera image 925 and uses the details of the eye image to compare subsequent user eye images to authenticate and recognize the authorized user of one embodiment.

The online lottery scratch-off user recognition authentication features 900 include in one embodiment a scratch-off agency issued user identification code 930. The online marketing lottery scratch-off method network 640 of FIG. 6 processes using at least one digital processor for the generation of a unique scratch-off agency issued user identification code 930 for each user. The scratch-off agency issued user identification code 930 includes using a barcode 932, QR code 934 or other code symbol method. The scratch-off agency issued user identification code 930 in one embodiment can be downloaded by the user for example to place in the user wallet 936. In another embodiment a scratch-off agency issued user identification code downloadable printed card 938 can be used by the user to scan using the device camera to be recognized and authenticate the user is authorized to use this account of one embodiment.

The online lottery scratch-off user recognition authentication features 900 include in one embodiment includes a device microphone voice recognition password 940. A device microphone voice recognition digital apparatus 950 includes a user speaking the desired password into device microphone 960. The voice recognition digital apparatus records the user voice characteristics 962 using a device with microphone and voice recognition digital application 964. The device with microphone and voice recognition digital application 964 is used to record, analyze and store in a database 970 the user voice characteristics 962. The user voice characteristics 962 can be shown as a voice recognition voice password data record in graphic display 980 of one embodiment.

### Scratching Can be Done by a Finger Swipe

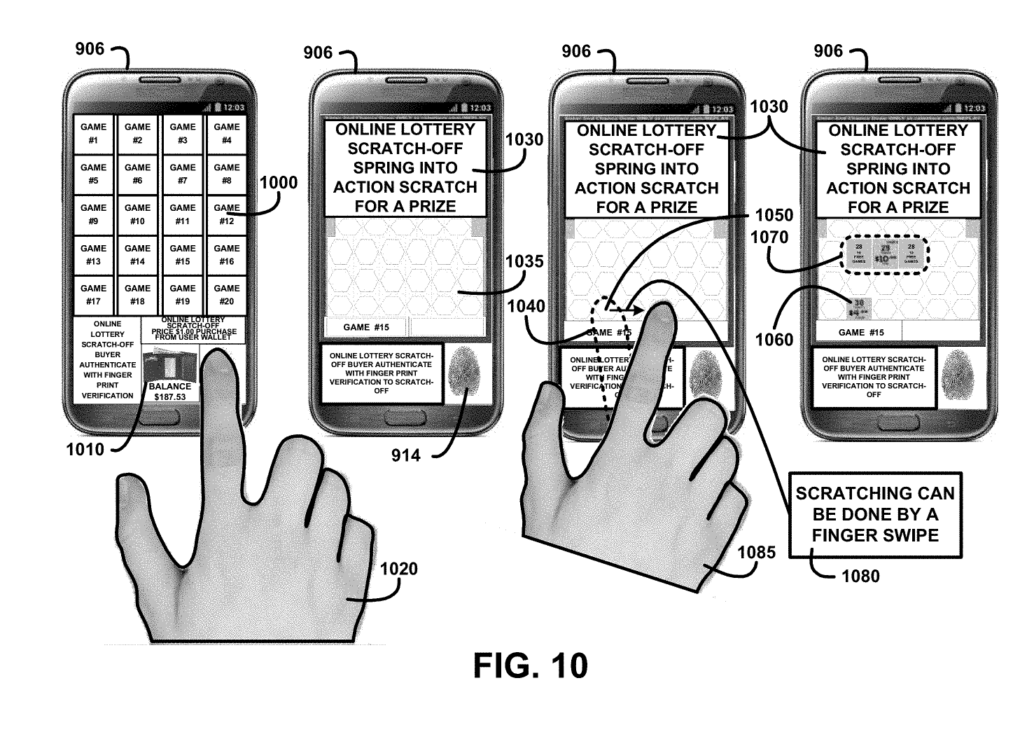

FIG. 10 shows for illustrative purposes only an example of scratching can be done by a finger swipe of one embodiment. FIG. 10 shows in one embodiment scratching can be done by a finger swipe using the device 906 including touch screen and pressure/temperature features. A downloaded from the online marketing lottery scratch-off method will display online lottery scratch-off game selections #1-20 displayed on the user device 1000. A user taps game selected to play then in one embodiment a user enters fingerprint to authorize payment from the user wallet 1020. The device displays an online lottery scratch-off price $1.00 purchase from user wallet. A user taps user wallet to pay for scratch-off game selected 1010 of one embodiment.

The user can win free games as a prize. The balance of unused free games is shown in the user wallet balances. Free game prizes increases the amount of play a user can experience without taking away from cash they may need to pay bills. This feature helps to reduce a costly gambling habit. At the same time it provides the companies greater access to players to advertise. This feature also provides an opportunity to open online marketing lottery scratch-off methods in states and locales where winning cash might not be permitted. In most areas winning prizes is legal and not prohibited. Free game play will not be considered wagering or a game of chance. The companies can still advertise and the online marketing lottery scratch-off method operators still receive advertising revenue.

An online lottery scratch-off buyer authenticate with finger print verification is used and a user selected game #15 downloaded to the user device 1030. The user finger print displayed 914 is used to compare with the finger print provided. A game #15 prize boxes displayed 1035 on the device is reviewed by a user to decide where to begin in one embodiment a process where scratching can be done by a finger swipe 1080. The process includes a user finger placed on box to open 1050, then a user swipes finger 1040 across the box and the process clears the box covering showing a box opened to show prize in box 1060. The finger swipe scratching embodiment includes an instance where a user finger can swipe multiple boxes 1085 and multiple boxes can be opened with one swipe 1070 of one embodiment.

### Identification Code Verification to Scratch-Off

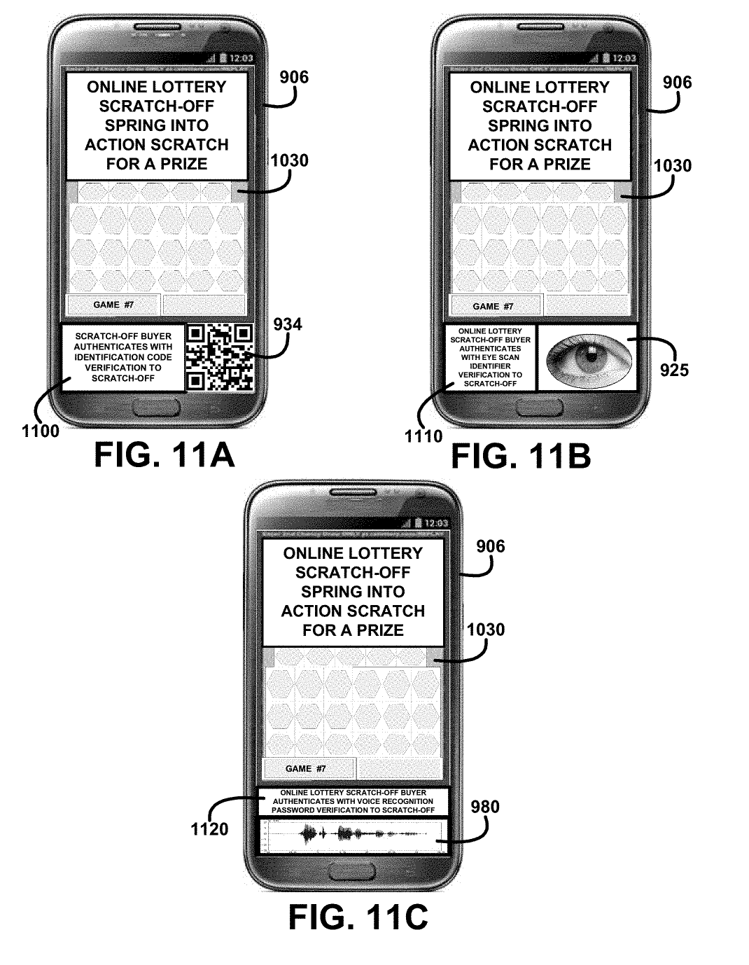

FIG. 11A shows for illustrative purposes only an example of an identification code verification to scratch-off of one embodiment. FIG. 11A shows in one embodiment an identification code verification to scratch-off using the device 906. Shown is the QR code 934 issued to the user. A user selected game #7 downloaded to the user device 1030 will be playable and scratchable when a scratch-off buyer authenticates with identification code verification to scratch-off 1100 of one embodiment.

### Eve Scan Identifier Verification to Scratch-Off

FIG. 11 B shows for illustrative purposes only an example of an eye scan identifier verification to scratch-off of one embodiment. FIG. 11B shows in one embodiment eye scan identifier verification to scratch-off including using a device 906 including a camera. A user selected game #7 downloaded to the user device 1030 becomes playable and scratchable when the user using the device camera images the user's eye and it is successfully is compared to the user eye camera image 925 stored on the device. The online lottery scratch-off buyer authenticate with eye scan identifier verification to scratch-off 1110 is used to recognize the user authorized to use the account of one embodiment.

### Voice Recognition Password Verification to Scratch-Off

FIG. 11C shows for illustrative purposes only an example of a voice recognition password verification to scratch-off of one embodiment. FIG. 11C shows in one embodiment voice recognition password verification to scratch-off using a device 906 including a microphone. A user selected game #7 downloaded to the user device 1030. The user speaking into the device microphone says the password. The device voice recognition password verification application compares this with the voice recognition voice password data record in graphic display 980. If the voice recognition is verified then the online lottery scratch-off buyer authenticate with voice recognition password verification to scratch-off 1120 is cleared and the user can begin scratching the prize boxes of one embodiment.

### Scratching by Eve Position Motion Detection

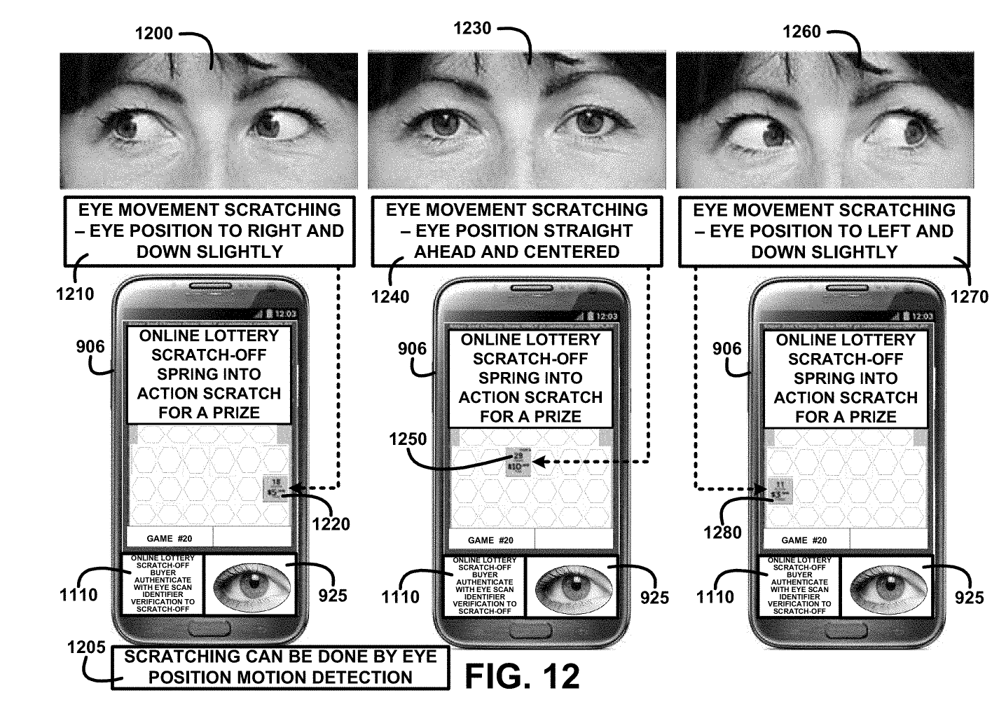

FIG. 12 shows for illustrative purposes only an example of scratching by eye position motion detection of one embodiment. FIG. 12 shows in one embodiment scratching by eye position motion detection. In the illustration is shown an eye movement right image 1200. An eye movement scratching—eye position to right and down slightly 1210 is captured by the camera of the device 906. In these illustrations it should be remembered that the eyes face the camera and in this illustration appear opposite to the directions left and right of one embodiment.

Scratching can be done by eye position motion detection 1205 where the online lottery scratch-off buyer authenticate with eye scan identifier verification to scratch-off 1110 is used to recognize the user eye camera image 925. The eye movement scratching—eye position to right and down slightly 1210 is used where a user eye movement scratches open prize box on right side lower than the center 1220. User eye movements may include a box selection number of rapid blinks or eye closure to activate the swipe. An eye movement center image 1230 is used for eye movement scratching—eye position straight ahead and centered 1240 and a user eye movement scratches open prize box in center position 1250. An eye movement left image 1260 is used for eye movement scratching—eye position to left and down slightly 1270 and a user eye movement scratches open prize box on the left side lower than the center position 1280 of one embodiment.

### Shaking Device to Scratch-Off Prize Coverings

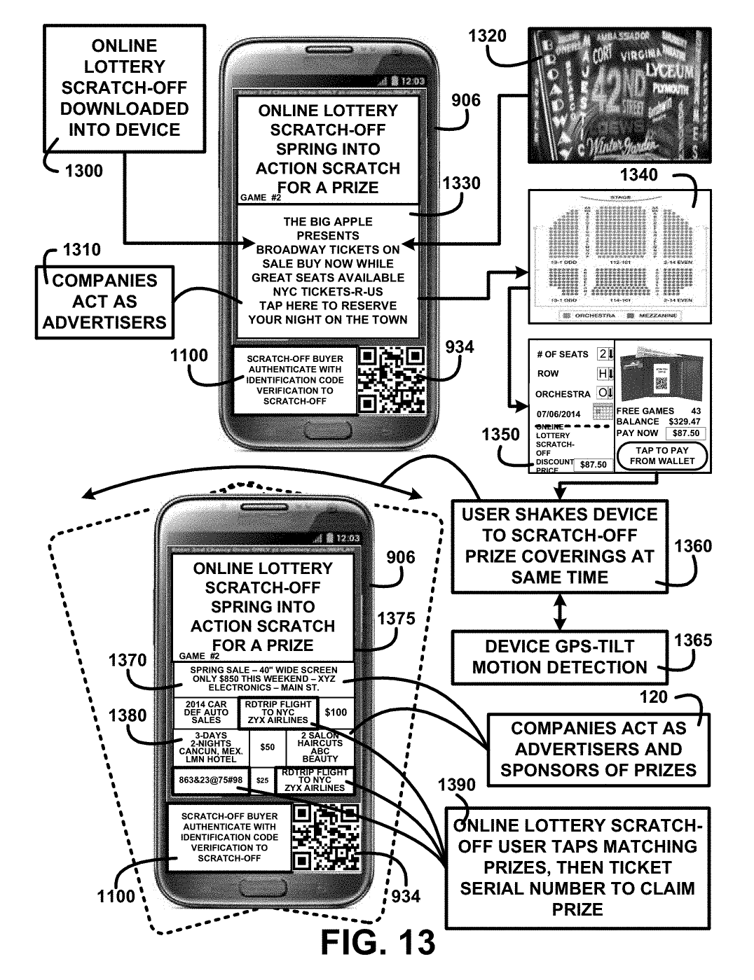

FIG. 13 shows for illustrative purposes only an example of shaking device to scratch-off prize coverings of one embodiment. FIG. 13 shows in one embodiment shaking device to scratch-off prize coverings of an online lottery scratch-off downloaded into device 1300. The device 906 including device GPS-tilt motion detection 1365 can use the QR code 934 scratch-off buyer authenticate with identification code verification to scratch-off 1100 of one embodiment.

Companies act as advertisers 1310 including placing for example an opening ad screen display 1320 configured where this screen content can be animated with blinking marquee lights and Broadway show tones playing. The animated screen can fade to the text ad content for example “the big apple presents Broadway tickets on sale buy now while great seats available NYC tickets-r-us tap here to reserve your night on the town” 1330. The user can swipe to go directly to the prize boxes or tap as instructed to continue further with the ad. A user tap takes the user to the seating chart 1340 where the user selects the desired # of seats (2) from a drop-down list, selects the desired row (H) from a drop-down list, and selects the proximity to the stage (orchestra) from a drop-down list. The tickets price is displayed and the user can elect to pay from the user's online lottery scratch-off wallet by tapping as instructed 1350. After payment or cancellation this ad closes and the prize box area is displayed of one embodiment.

In one embodiment a user shakes device to scratch-off prize coverings at same time 1360. Companies act as advertisers and sponsors of prizes 120 for example in a user selected game #2 downloaded to the user device 1375. A sponsoring company can place an ad in the prize box header area 1370 for example “Spring Sale—40” Wide Screen Only $850 This Weekend—XYZ Electronics—Main St.”. This ad can be for a local company determined by the user GPS location of one embodiment.

The uncovered prize boxes reveal prizes that include a car, cash, salon services, hotel vacation rooms, and travel 1380. An online lottery scratch-off user taps matching prizes, then taps a ticket serial number to claim prize 1390. The claimed prize information is automatically transmitted to the online marketing lottery scratch-off method where the order is processed to send via email, postal service or package carrier any physical prizes. In tangible prizes including free games and cash can be credited directly to the user wallet. In other instances show tickets, tickets to a sporting event and other of this type can be will-called and the verification information transmitted as a text message to the user device wherein the user can display the message to for example pick-up will-call tickets. Prizes including cars for example too large to ship can be claimed using the verification transmitted to the user's device and presented for example to the car dealership sponsoring the prize. The online marketing lottery scratch-off method expands the reach of this widely accepted consumer entertainment to enter the retailing and services market and provide player/users an opportunity to win a greatly expanded range of prizes without fear of developing a potential financial collapse from a gambling habit of one embodiment.

### Reporting Winning Prizes

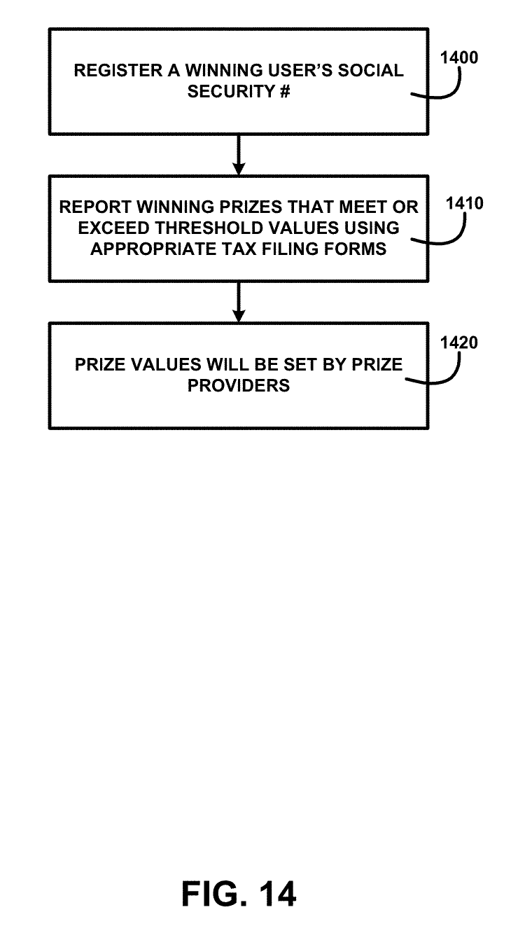

FIG. 14 shows a block diagram of an overview of reporting winning prizes of one embodiment. FIG. 14 shows the online marketing lottery scratch-off method 100 of FIG. 1 process for reporting winning prizes. In one embodiment the online marketing lottery scratch-off method network 640 of FIG. 6 is used to register a winning user's social security #1400 in at least one database 501 of FIG. 5 that was received from one of the user digital devices 540 of FIG. 5 after they have won a prize. The online marketing lottery scratch-off method network 640 of FIG. 6 analyzes the prize value to report winning prizes that meet or exceed threshold values using appropriate tax filing forms 1410. Prize values will be set by prize providers 1420.

The online marketing lottery scratch-off method network 640 of FIG. 6 prints both electronically and using a printer coupled to the network a hard copy of the appropriate tax filing forms and files the electronic copies with the appropriate tax agency and winning user. The online marketing lottery scratch-off method network 640 of FIG. 6 prints an addressed mailing envelope and automatically folds and inserts the appropriate tax filing forms into the addressed mailing envelope using a mail processing device coupled to the network which places the sealed envelope in a mail pickup container of one embodiment.

### A User Smart Phone Sign In

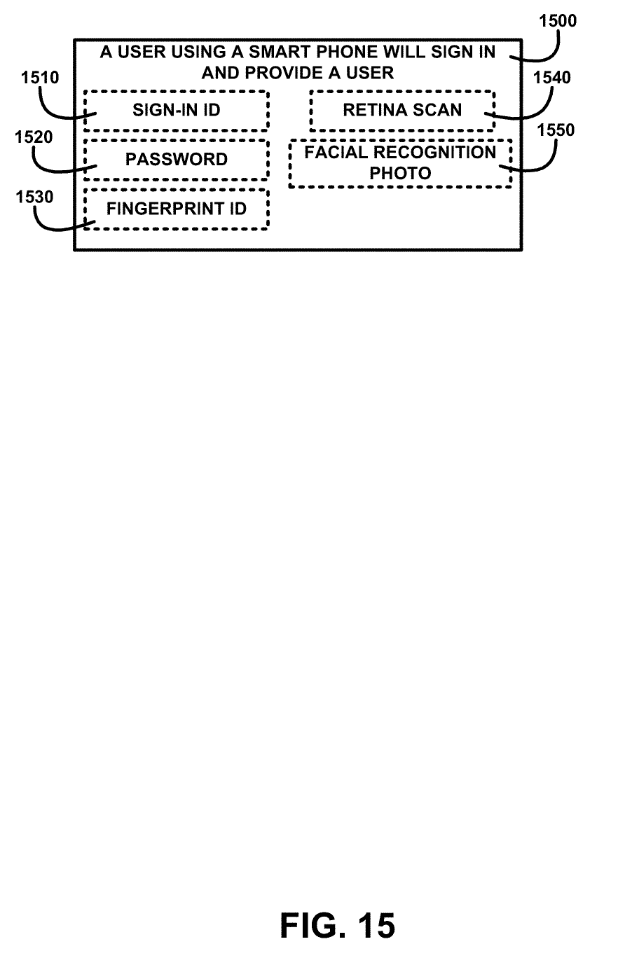

FIG. 15 shows a block diagram of an overview of a user smart phone sign in of one embodiment. FIG. 15 shows the online marketing lottery scratch-off method network 640 of FIG. 6 security user sign-in process wherein a user using a smart phone will sign in and provide a user 1500 identification. A user identification can include a sign-in ID 1510, password 1520; fingerprint ID 1530, retina scan 1540, facial recognition photo 1550 and other forms of unique identification of one embodiment.

### Marketing Opportunity for Companies

FIG. 16 shows for illustrative purposes only an example of marketing opportunity for companies of one embodiment. FIG. 16 shows an online marketing lottery scratch-off 1600 used for a marketing opportunity for companies 1610. The online marketing lottery scratch-off 1600 wherein companies act as advertisers and sponsors of prizes 120 for example prizes can include vacations and travel 155. The number of potential prizes of each type and the odds of winning any prize will be published on the vacation online marketing lottery scratch-off website. FIG. 16 shows an example where a user clicks on a company sponsored Hawaiian vacation online marketing lottery scratch-off website 1620. The company sponsored Hawaiian vacation online lottery scratch-off website 1630 includes online marketing ads 1640, an online marketing lottery scratch-off tool 1650, and an online lottery scratch-off ticket first display scratch off to play 1660. When a user uses the online marketing lottery scratch-off tool 1650 to uncover the first scratch off to play 1660 section a marketing series of questions are displayed 1670. The user will check mark click the box next to the appropriate selection to show their marital status are married, single, engaged, ????, honeymoon. Other scratch off to play 1660 sections may not include marketing questions.

The third scratch off to play 1660 section queries their income level and the user can check mark click income:>$50,000 or check mark click income:>$100,000. The fourth scratch off to play 1660 section questions how many vacations the user takes per year. The user can check mark click annual vacations: 1, check mark click annual vacations: 2 or check mark click annual vacations: >2. After the user responds to the marketing questions an online lottery scratch-off ticket third prize display 1680.

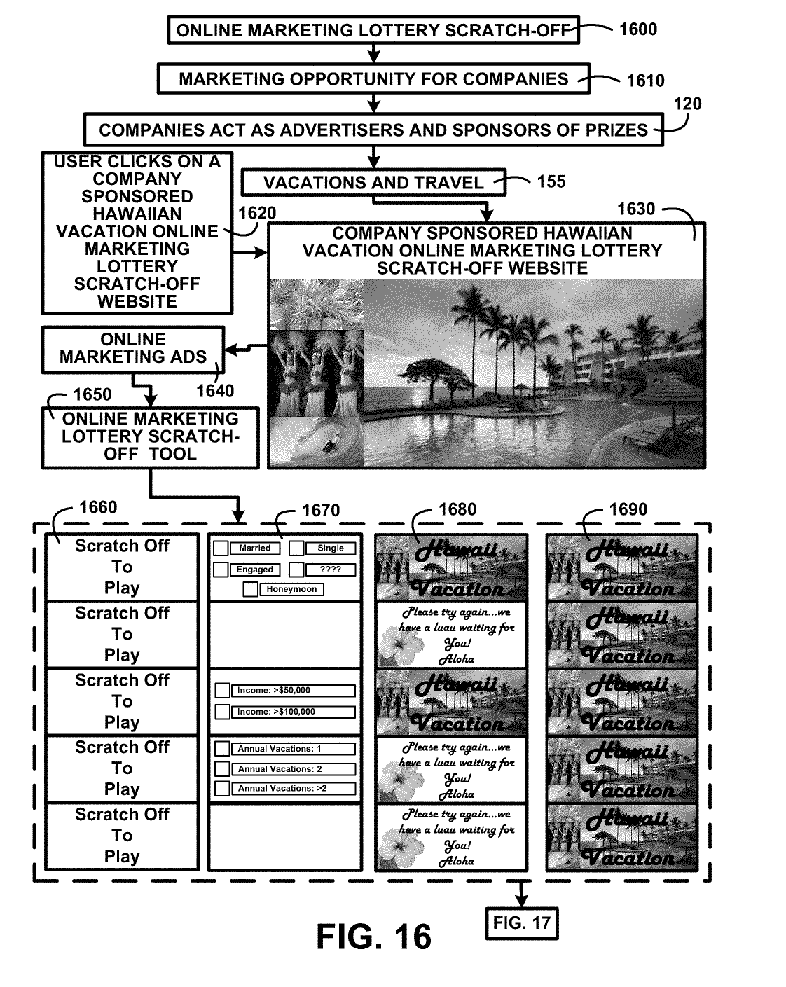

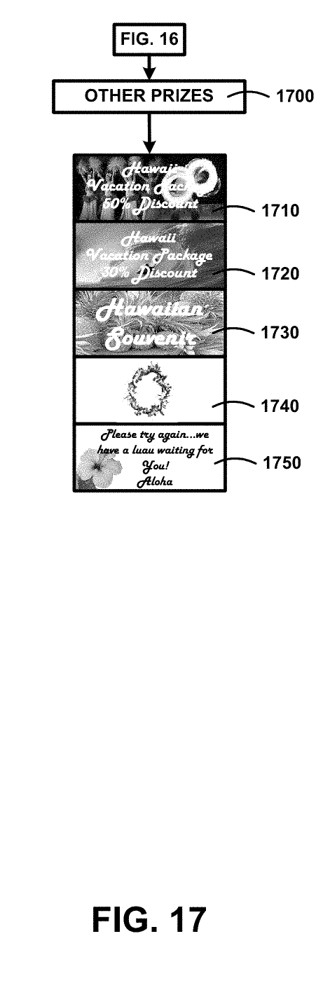

The user using the online marketing lottery scratch-off tool 1650 reveals the prize sections and finds “Hawaii vacation”, “Please try again . . . we have a luau waiting for you! Aloha”, “Hawaii vacation”, “Please try again . . . we have a luau waiting for you! Aloha”, and “Please try again . . . we have a luau waiting for you! Aloha” and they did not win a Hawaii vacation. Also shown in this example is an online marketing lottery scratch-off ticket prize winning ticket display 1690 that includes 5 “Hawaii vacation” images. An online marketing lottery scratch-off ticket can include other prizes as shown in FIG. 17 of one embodiment.

### Other Prizes

FIG. 17 shows for illustrative purposes only an example of other prizes of one embodiment. FIG. 17 shows other prizes 1700 as described in FIG. 16. The other prizes 1700 include Hawaii vacation package 50% discount 1710, Hawaii vacation package 30% discount 1720, Hawaiian souvenir 1730, a flower lei 1740 and “Please try again . . . we have a luau waiting for you! Aloha” 1750. The prizes can be varied randomly from one ticket to another of one embodiment.

### Pickup Truck Marketing Scratch-Off Prizes

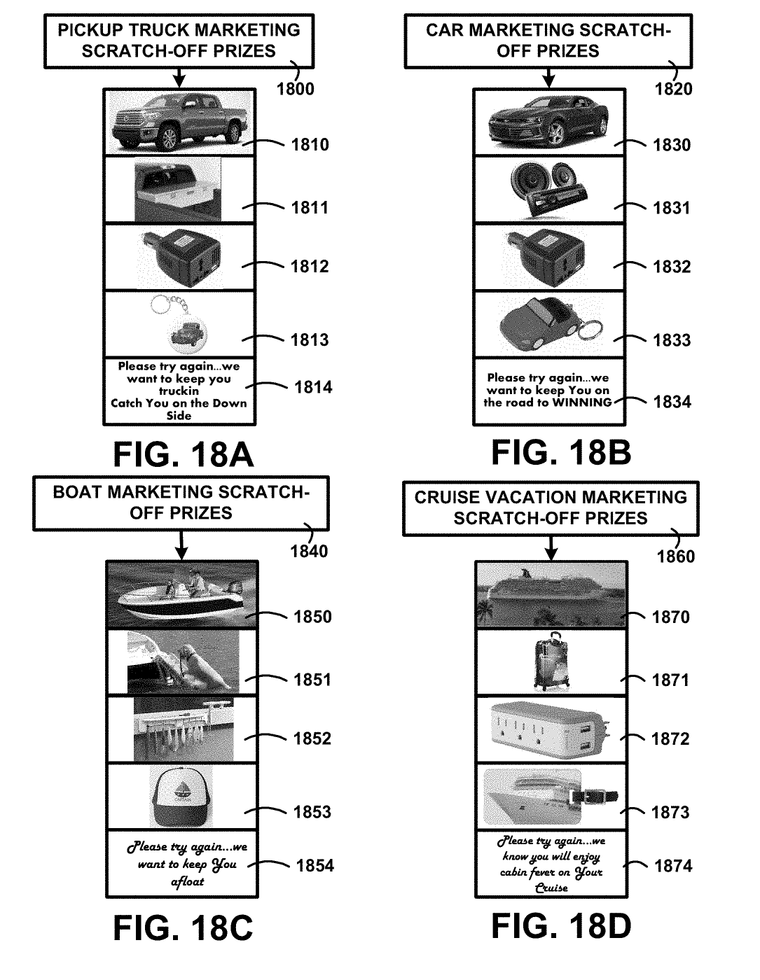

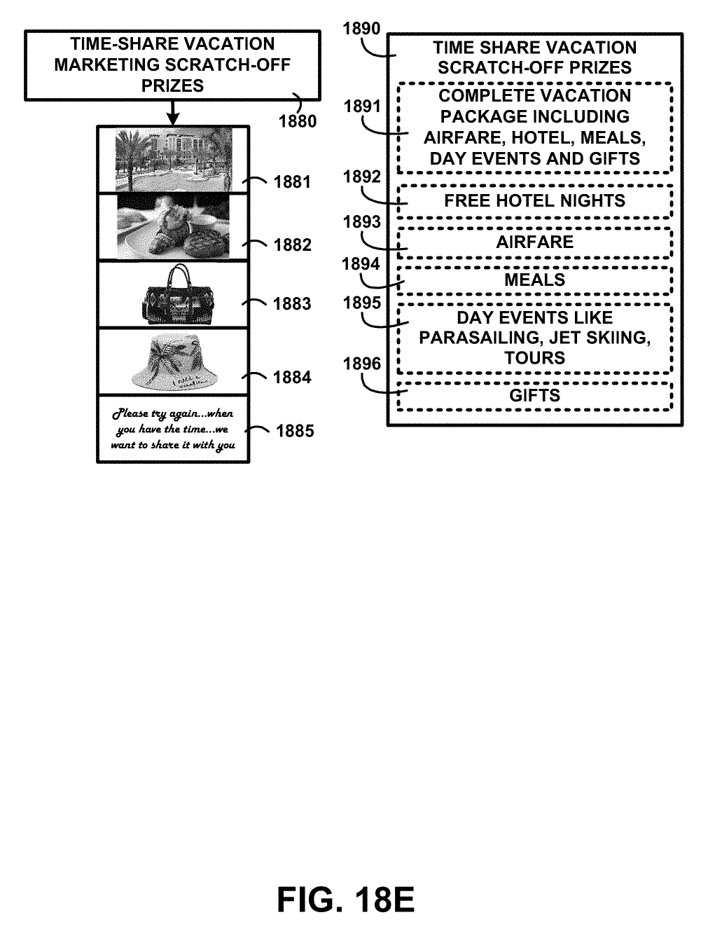

FIG. 18A shows for illustrative purposes only an example of pickup truck online marketing lottery scratch-off prizes of one embodiment. FIG. 18A shows for example pickup truck online marketing lottery scratch-off prizes 1800. The pickup truck online marketing lottery scratch-off prizes 1800 can include a new pickup truck 1810, a pickup truck bed tool box 1811, a vehicle cigarette lighter dc-ac power inverter 1812, a vintage pickup truck key chain 1813, and a no prize “Please try again . . . we want to keep you truckin catch you on the down side” 1814 of one embodiment.

### Car Marketing Scratch-Off Prizes

FIG. 18B shows for illustrative purposes only an example of car online marketing lottery scratch-off prizes of one embodiment. FIG. 18B shows for example car online marketing lottery scratch-off prizes 1820. The car online marketing lottery scratch-off prizes 1820 can include a new car 1830, a car stereo 1831, a vehicle cigarette lighter DC-AC power inverter 1832, a toy car key ring 1833, and a no prize “Please try again . . . we want to keep you on the road to winning” 1834 of one embodiment.

### Boat Marketing Scratch-Off Prizes

FIG. 18C shows for illustrative purposes only an example of boat online marketing lottery scratch-off prizes of one embodiment. FIG. 18C shows for example boat online marketing lottery scratch-off prizes 1840. The boat online marketing lottery scratch-off prizes 1840 can include a new boat 1850, a boat pet ladder 1851, a fishing lure rack 1852, a captain ball cap 1853, and a no prize “Please try again . . . we want to keep you afloat” 1854 of one embodiment.

### Cruise Vacation Marketing Scratch-Off Prizes

FIG. 18D shows for illustrative purposes only an example of cruise vacation online marketing lottery scratch-off prizes of one embodiment. FIG. 18D shows for example cruise vacation online marketing lottery scratch-off prizes 1860. The cruise vacation online marketing lottery scratch-off prizes 1860 can include a cruise ship vacation 1870, a travel roller bag 1871, a multi-plug adapter 1872, a cruise ship luggage tag 1873, and a no prize “Please try again . . . we know you will enjoy cabin fever on your cruise” 1874 of one embodiment.

### Time-Share Vacation Marketing Scratch-Off Prizes

FIG. 18E shows for illustrative purposes only an example of time-share vacation online marketing lottery scratch-off prizes of one embodiment. FIG. 18E shows for example time-share vacation online marketing lottery scratch-off prizes 1880. The time-share vacation online marketing lottery scratch-off prizes 1880 can include a time-share resort vacation 1881, a surf & turf dinner for two 1882, a travel bag 1883, an “I need a vacation” hat 1884, and a no prize “Please try again . . . when you have the time . . . we want to share it with you” 1885. Time share vacation scratch-off prizes 1890 include for example a complete vacation package including airfare, hotel, meals, day events and gifts 1891, free hotel nights 1892, airfare 1893, meals 1894, day events like parasailing, jet skiing, tours 1895, and gifts 1896 of one embodiment.

### Online Marketing Lottery Scratch-Off Method Database Customer Data Collected for Targeted Purposes

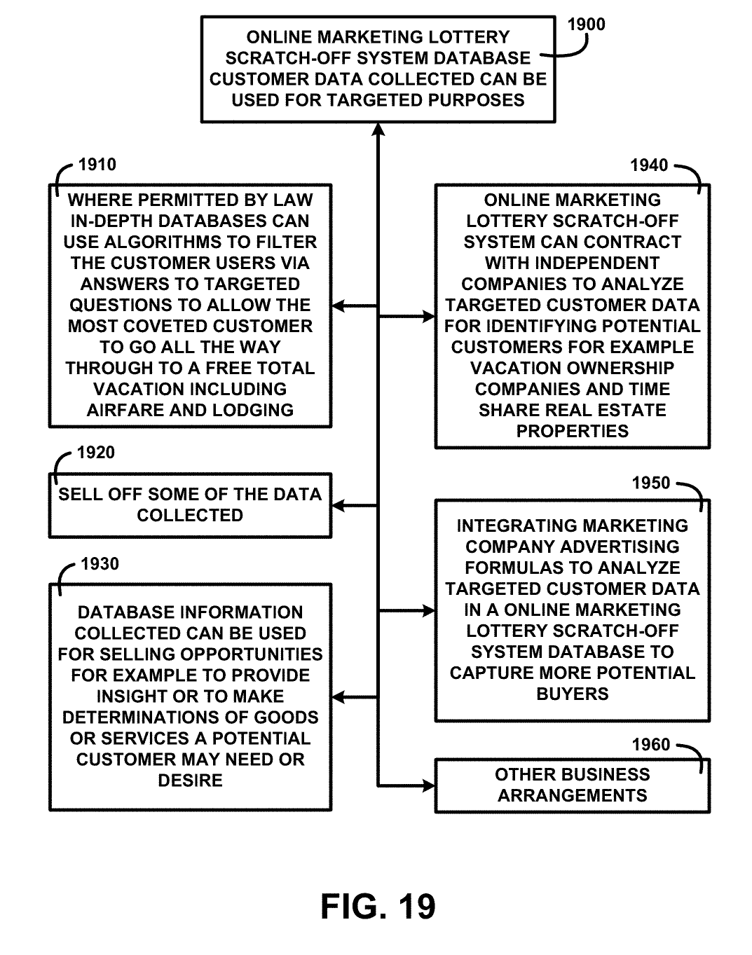

FIG. 19 shows a block diagram of an overview of online marketing lottery scratch-off method database customer data collected for targeted purposes of one embodiment. FIG. 19 shows online marketing lottery scratch-off method database customer data collected can be used for targeted purposes 1900. Targeted purposes for example can include where permitted by law in-depth databases can use algorithms to filter the customer users via answers to targeted questions to allow the most coveted customer to go all the way through to a free total vacation including airfare and lodging 1910, sell off some of the data collected 1920, database information collected can be used for selling opportunities for example to provide insight or to make determinations of goods or services a potential customer may need or desire 1930, online marketing lottery scratch-off method can contract with independent companies to analyze targeted customer data for identifying potential customers for example vacation ownership companies and time share real estate properties 1940, integrating marketing company advertising formulas to analyze targeted customer data in an online marketing lottery scratch-off method database to capture more potential buyers 1950, and other business arrangements 1960 of one embodiment.

### A Group Lotto Method

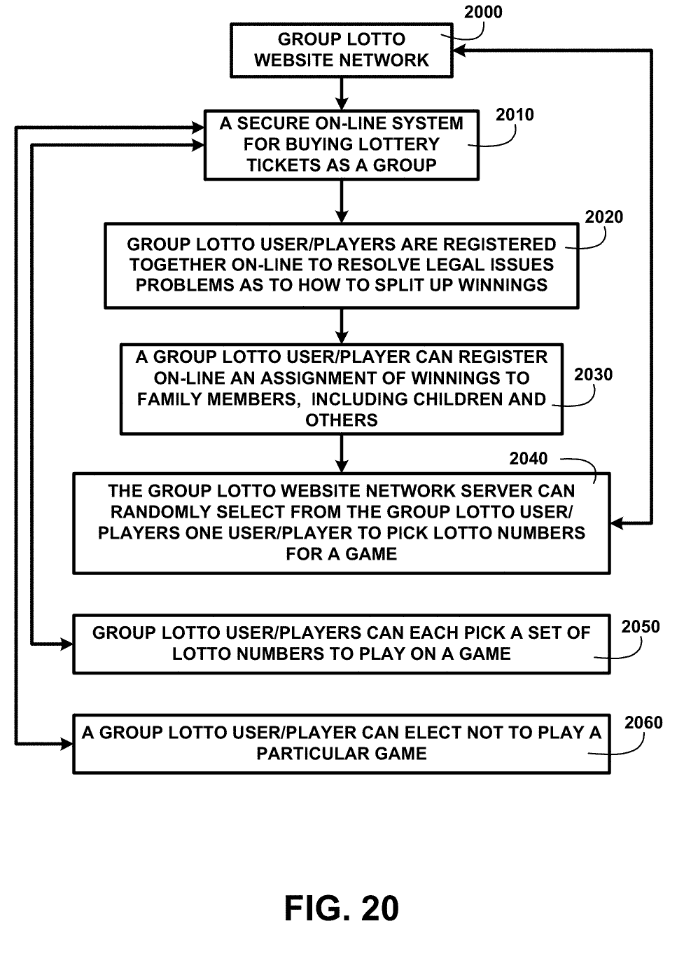

FIG. 20 shows a block diagram of an overview of a group lotto method of one embodiment. FIG. 20 shows a group lotto website network 2000. The group lotto website network 2000 is used to create a secure on-line method for buying lottery tickets as a group 2010. Group lotto user/players are registered together on-line to resolve legal issues problems as to how to split up winnings 2020. A group lotto user/player can register on-line an assignment of winnings to family members, including children and others 2030. The group lotto website network server can randomly select from the group lotto user/players one user/player to pick lotto numbers for a game 2040. Group user/players can each pick a set of lotto numbers to play on a game 2050. A group lotto user/player can elect not to play a particular game 2060 of one embodiment.

### A Group Lotto Website Network

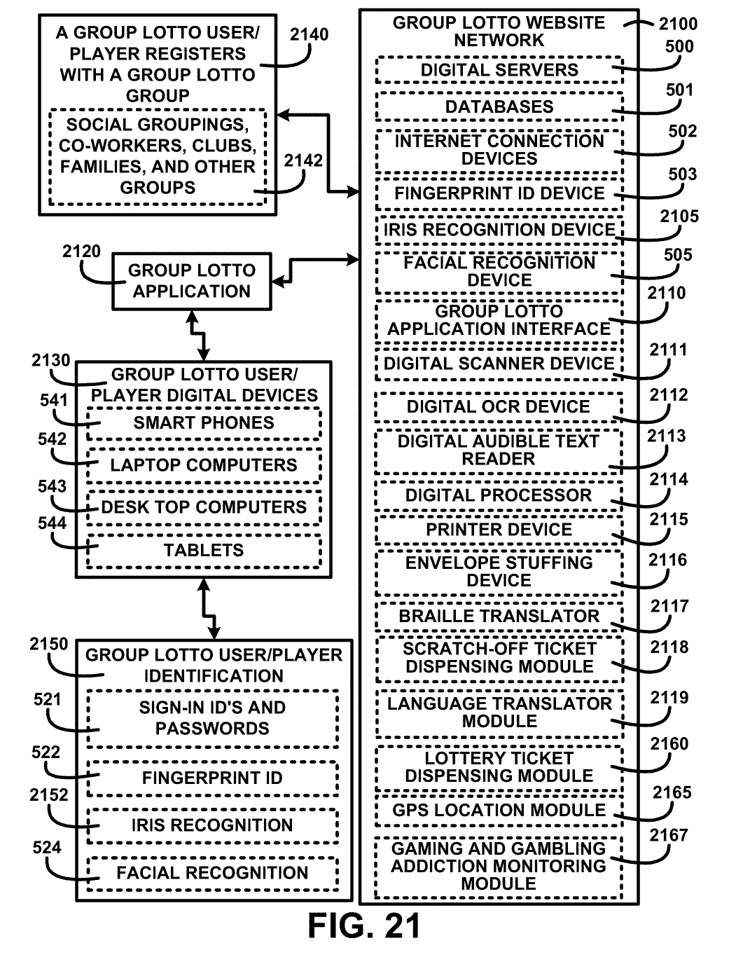

FIG. 21 shows a block diagram of an overview of a group lotto website network of one embodiment. FIG. 21 shows a group lotto website network 2100 including digital servers 500, at least one database 501, internet connection devices 502, sign-in security devices including a fingerprint ID device 503, iris recognition device 2105, and a facial recognition device 505. The group lotto website network 2100 also includes a group lotto application interface 2110 used for interactive processes using a group lotto application 2120 installed on group lotto user/player digital devices 2130. The group lotto website network 2100 also includes a digital scanner device 2111, digital OCR device 2112, and a digital audible text reader 2113 for use with a group lotto user/player who may have vision problems, braille translator 2117, language translator module 2119, scratch-off ticket dispensing module 2118, GPS location module 2165, lottery ticket dispensing module 2160, and gaming and gambling addiction monitoring module 2167. The group lotto website network 2100 additionally includes at least one digital processor 2114 used for performing calculations and analysis of group lotto user/player selected options. The group lotto website network 2100 includes a printer device 2115, and an envelope stuffing device 2116 for use for example in preparing appropriate tax reporting forms for winnings above the taxing thresholds and used to send the same to each group lotto user/player in accordance with the percentage of winnings predetermined by the group lotto user/players and alternatively by an automatic analysis and calculation based on each group lotto user player's contribution to the purchase of a winning ticket of one embodiment.

A group lotto user/player registers with a group lotto group 2140 including social groupings, co-workers, clubs, families, and other groups 2142. The group lotto application 2120 can be downloaded from the group lotto website network 2100 and installed on group lotto user/player digital devices 2130 including smart phones 541, laptop computers 542, desk top computers 543, and tablets 544. A group lotto user/player can login using the group lotto application 2120 entering their group lotto user/player identification 2150 to make a secure connection to the group lotto website network 2100. The group lotto user/player can login includes entering sign-in ID's and passwords 521, applying an assigned finger for a fingerprint ID 522, activating an iris recognition 2152, and taking a selfie for a facial recognition 524 of one embodiment.

### A Group Lotto Secure Sign-In

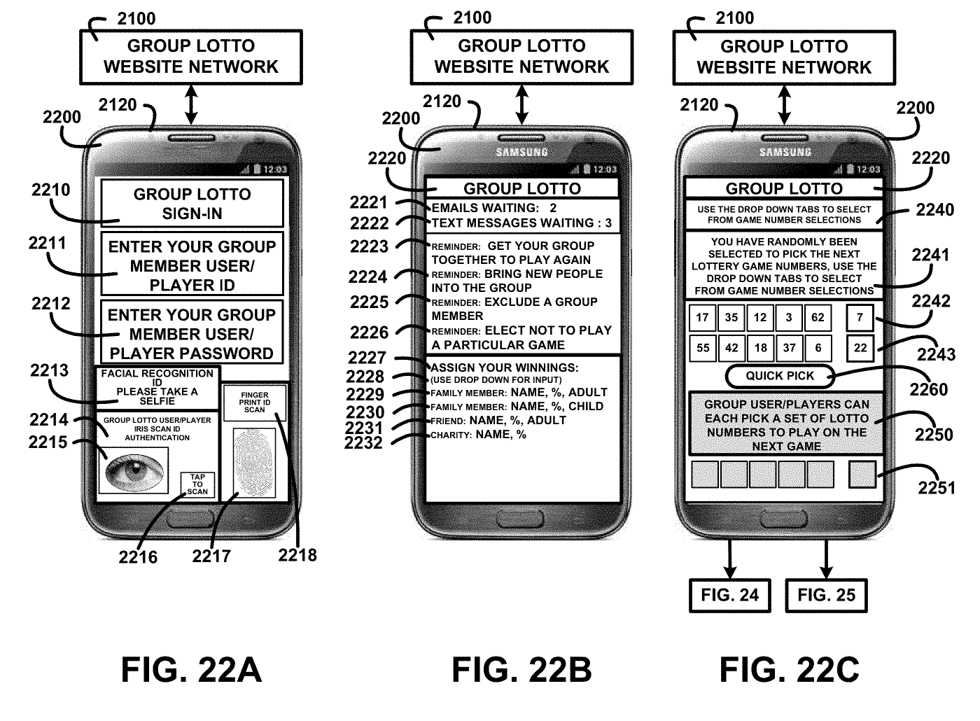

FIG. 22A shows for illustrative purposes only an example of a group lotto secure sign-in process of one embodiment. FIG. 22A shows the group lotto website network 2100 connected to a group lotto user/player smart phone 2200 using the group lotto application 2120 displaying a group lotto sign-in process 2210. To create a secure connection a group lotto user/player can follow the on-screen instructions including enter your group member user/player ID 2211, enter your group member user/player password 2212, facial recognition ID please take a selfie 2213, group lotto user/player iris scan ID authentication 2214, position your eye over the iris image capture device 2215, tap to scan 2216, and finger print ID scan 2218, press your appropriate finger on the thermal imaging device 2217 of one embodiment.

The ID process using the facial recognition uses a group lotto user/player image stored on one of the databases at the time of them registering. The group lotto website network 2100 analyzes the original image using a digital mapping process and performs the same analysis on the login image. Both facial images are in 3D providing width (x), height (y) and depth (z) coordinates. The use of 3D facial images prevents someone from putting a picture in front of the camera to fake a person's face. The group lotto application 2120 includes a range finder device that uses sound and light to measure a distance for example from a tip of a nose to a cheek, eye, forehead, chin and mouth. Sound is capture using the shutter snap of for example a smart phone camera flash and the smart phone microphone. The time taken from the first response of the shutter snap to the last response allows a distance measurement using the speed of sound. Light from the flash reflects of the facial features and the first reflection to the last reflection using the speed of light provides a distance measurement of each of the facial features. The facial feature analysis includes an infrared analysis wherein the residual heat of the flash is captured in milliseconds during the selfie and also provides a distance measurement from highest to lowest temperature fluctuation.

The coordinates of the login image are correlated to the original to determine a percentage of corresponding x, y and z coordinates matchups. If the login image mapping coordinates are determined to meet or exceed the threshold percentage of corresponding coordinates matchups then the facial recognition is authenticated, if not the login is disconnected automatically.

The ID process using the group lotto user/player iris scan ID authentication 2214 uses the login iris image captured and an analysis is preformed wherein the login iris image is mapped for both topographic features and color. The login iris scan is analyzed and to determine physical feature coordinates and the corresponding color analyzed for example using a RGB color code. A percentage of corresponding matchups with the original iris scan analysis of the group lotto user/player submitted when registering is performed. If the login image mapping coordinates are determined to meet or exceed the threshold percentage of corresponding coordinates matchups then the iris scan ID authentication is authenticated, if not the login is disconnected automatically.

The ID process using the group lotto user/player finger print ID scan 2218 captures a thermal image of the group lotto user/player finger print. The thermal image captures the ridges and valleys features of the finger print and heat levels across the finger print area. The login finger print thermal image is analyzed and mapped producing coordinates of the ridges and valleys and corresponding heat values. The thermal imaging detects additional marks including past cuts, abrasions and other unique features. The heat values are analyzed to determine any subdermal circulatory conditions including for example abnormal distribution of heat due to a past broken bone, poor circulation and other anomalies not observable on the surface and mapped to correlate to the coordinates of the ridges and valleys. A percentage of corresponding matchups with the original finger print of the group lotto user/player submitted when registering is performed. If the login image mapping coordinates are determined to meet or exceed the threshold percentage of corresponding coordinates matchups then the finger print ID scan 2218 is authenticated, if not the login is disconnected automatically.

The multi-layer security measures are to prevent another person from claiming a potentially large amount of a winning lottery ticket. If any one of the group lotto sign-in process 2210 security ID qualification cannot be authenticated the person cannot connect to the group lotto data. A legitimate group lotto user/player who does not receive authentication can request a majority of the remaining group lotto user/players to login in and fill out their authentication that the legitimate group lotto user/player is in fact a member of that group lotto group. The legitimate can then be authorized to resubmit their security measure base information with a new group member user/player ID 2211 including password, facial image, iris scan and fingerprint thermal image of one embodiment.

### A Group Lotto User/Player Interactive Processes

FIG. 22B shows for illustrative purposes only an example of a group lotto user/player interactive processes of one embodiment. FIG. 22B shows the group lotto website network 2100 connected to the group lotto user/player smart phone 2200 using the group lotto application 2120. After a successful login a group lotto 2220 display shows emails waiting: 2 2221 and text messages waiting: 3 2222. The group lotto user/player can tap on those items and see the emails and text messages.

The group lotto website network 2100 also displays a series of reminders for the group lotto user/player. The group lotto user/player can tap on reminder: get your group together to play again 2223 and the group lotto website network 2100 will automatically send an email and text message to the other group lotto group user/players to suggest playing the lottery again. The group lotto user/player can tap on reminder: bring new people into the group 2224 to enter a new person's name and contact information as instructed with the automatically displayed input information.

The group lotto user/player can tap on reminder: exclude a group member 2225 and the group lotto website network 2100 automatically displays a questionnaire asking is this exclusion permanent, temporary or for only one game and the reason for example the excluded user/player is on vacation trip out of the lottery authorized area. The group lotto user/player can tap on reminder: elect not to play a particular game 2226 automatically displaying the name and date of the next game and providing an input answer yes or not. This is repeated for each lottery game the user/player normally is playing.

The group lotto website network 2100 automatically displays an input for a group lotto player to assign your winnings: 2227. The group lotto user/player is instructed to (use drop down for input) 2228. The drop down lists various categories for type of person or entity for example a family member: name, %, adult 2229, a family member: name, %, child 2230, a friend: name, %, adult 2231 and a charity: name, % 2232. The list of assignees is displayed for the user/player after each login to refresh their memory and give them the opportunity to make changes of one embodiment.

### A Group Lotto Lottery Number Selection Process

FIG. 22C shows for illustrative purposes only an example of a group lotto lottery number selection process of one embodiment. FIG. 22C shows the group lotto website network 2100 connected to the group lotto user/player smart phone 2200 using the group lotto application 2120. The group lotto website network 2100 displays the group lotto 2220 instructions to use the drop down tabs to select from game number selections 2240. Different lotteries use differing ranges of numbers for each pick and even a different range of numbers for a bonus number. The drop down tabs lists the approved ranges of numbers for the particular game selected by the group lotto user/player. When picking numbers the number selected by the user/player is highlighted in subsequent drop down listing to assist the group lotto user/player in not choosing an invalid double pick of the same number twice of one embodiment.

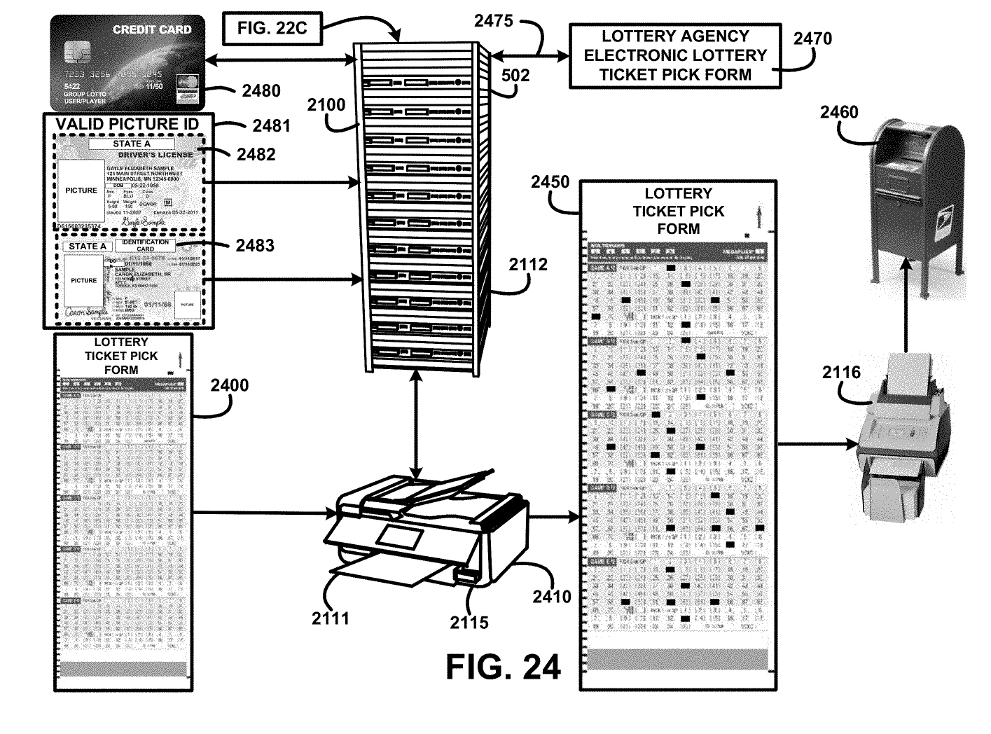

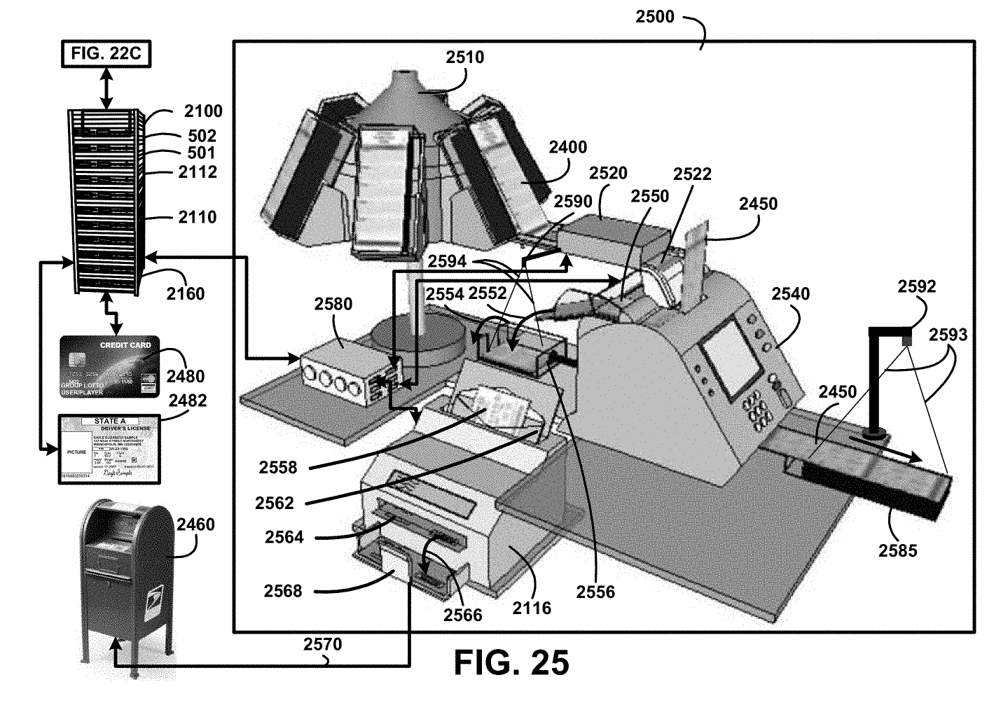

The group lotto website network 2100 highlights the sections notifying the group lotto user/player that you have randomly been selected to pick the next lottery game numbers, use the drop down tabs to select from game number selections 2241. The group lotto user/player selects a first set of lottery numbers 17, 35, 12, 3, 62, bonus number 7 2242 and a second set of lottery numbers 55, 42, 18, 37, 6, bonus number 22 2243. The group lotto website network 2100 automatically darkens the section group user/players can each pick a set of lotto numbers to play on the next game 2250 and a third set of lottery numbers 0, 0, 0, 0, 0, bonus number 0 2251 where 0 indicates no number selected. When a randomly selected user/player is not performed the group lotto website network 2100 lifts the darkening from the sections group user/players can each pick a set of lotto numbers to play on the next game 2250 and a third set of lottery numbers 0, 0, 0, 0, 0, bonus number 0 2251 and darkens the sections you have randomly been selected to pick the next lottery game numbers, use the drop down tabs to select from game number selections 2241. The group lotto user/player selects a first set of lottery numbers 17, 35, 12, 3, 62, bonus number 7 2242 and a second set of lottery numbers 55, 42, 18, 37, 6, bonus number 22 2243. A group lotto user/player may choose to elect a quick pick 2260 selection and take the numbers an official lottery ticket machine randomly select the numbers. A description a process continues in FIG. 24 of one embodiment. A description a process continues in FIG. 25 of one embodiment.

### A Group Lotto Lottery Ticket Process

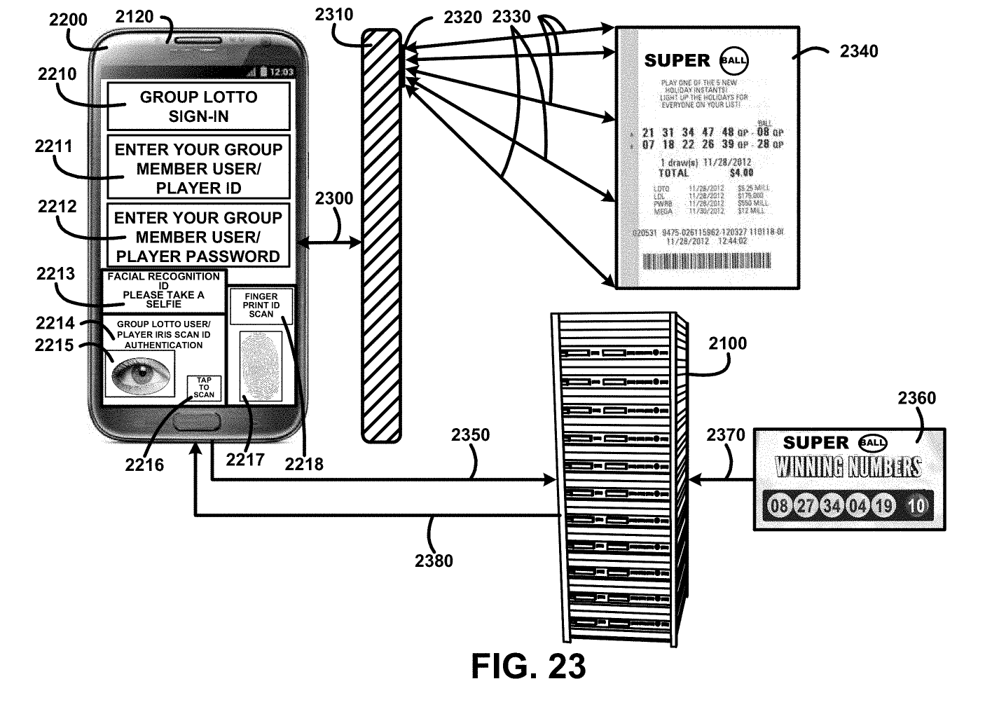

FIG. 23 shows for illustrative purposes only an example of a group lotto lottery ticket process of one embodiment. FIG. 23 shows the group lotto user/player smart phone 2200 using the group lotto application 2120 with the group lotto sign-in process 2210 including the instructions enter your group member user/player ID 2211, enter your group member user/player password 2212, facial recognition ID please take a selfie 2213, group lotto user/player iris scan ID authentication 2214, iris image capture device 2215, tap to scan 2216, finger print ID scan 2218, and thermal imaging device 2217. In this embodiment the user/player made a trip to a lottery ticket sales retailer location, filled out at least one appropriate lottery ticket pick form and purchased a lottery game ticket from the lottery ticket sales retailer.

After authenticated sign-in the group lotto user/player positions smart phone 2310 for taking a picture using the smart phone camera 2320 of at least one lottery game ticket purchased 2340 from the lottery ticket sales retailer. A picture of the lottery ticket purchased is captured 2330. The picture is captured and stored 2300 on the group lotto user/player smart phone 2200. The lottery ticket picture is wirelessly transmitted 2350 to the group lotto website network 2100 where a process using the digital OCR device identifies the ticket lottery numbers of one embodiment.

Lottery agencies complete the game and announce on television and radio, publish, and display on their website the winning numbers for each game played. The winning numbers are displayed 2360 for example on the lottery agency website and when the winning numbers are displayed they are captured by the group lotto website network 2370. The group lotto website network processes the lottery ticket purchased for winning numbers. The process results are tabulated and automatically wirelessly transmitted to each group lotto user/player digital device including a smart phone 2380 of one embodiment.

### An Automated Lottery Ticket Pick Form Process

FIG. 24 shows for illustrative purposes only an example of an automatic lottery ticket pick form process of one embodiment. FIG. 24 shows continuing the process on FIG. 22C the group lotto website network 2100 including the internet connection devices 502 and the digital OCR device 2112. A group lotto user/player submits a valid picture ID 2481 for example a driver's license 2482 or an identification card 2483 issued by the state to provide proof of legal age to purchase a lottery ticket. The group lotto user/player submits a form of payment including a credit or debit bank card 2480 to pay for tickets ordered and mailing completed lottery pick form(s). The group lotto website network 2100 transmits the group lotto numbers selected to a group lotto adapted printer module 2410 of one embodiment.

Appropriate lottery ticket pick forms 2400 for the game to be played are loaded into the group lotto adapted printer module forms tray 2111. The group lotto adapted printer module 2410 includes a group lotto adapted printer processor 2115 that converts the numbers selected by the group lotto group into corresponding mark-outs for the numbers displayed on the appropriate game lottery ticket pick form. The group lotto adapted printer processor downloads the game lottery ticket pick form number coordinate positions for the appropriate game. The group lotto adapted printer processor 2115 regulates the group lotto adapted printer module 2410 margins; line spacing and character(s) to be printed to clearly and accurately mark-out the selected numbers on the appropriate lottery ticket pick forms 2400. Marked-out appropriate lottery ticket pick forms are conveyed to a group lotto envelope stuffing device 2116 to process the forms for mailing to an appointed group lotto group address. The envelope containing the marked-out appropriate lottery ticket pick forms are picked up or delivered to the postal service 2460 or a private document delivery service of one embodiment.

This process assures the group lotto group appropriate lottery ticket pick forms are used and marked accurately to prevent any human error in selecting the correct form or in marking the ticket correctly. Additionally a group lotto group may be playing sufficient numbers to fill tens or hundreds of lottery ticket forms and the task of marking the tickets can become tedious and increase the chances of an error that could cost them a jackpot or high winning amount. The automated lottery ticket pick form process can be used for a lottery agency electronic lottery ticket pick form 2470 where available. The group lotto website network can fill out an electronic lottery ticket pick form 2470 and transmit a confirming receipt to the group lotto group of one embodiment.

### A Group Lotto Network Lottery Ticket Retailer Module

FIG. 25 shows for illustrative purposes only an example of a group lotto network lottery ticket retailer module of one embodiment. FIG. 25 shows continuing the process on FIG. 22C. FIG. 25 shows a group lotto network lottery ticket retailer module 2500. Many states use physical locations for example convenience stores, grocery stores and other types of retail locations to have retailers sell the lottery and scratch-off game tickets. The opportunity for sales of lottery tickets is limited to store hours and days open for business and the number of customers entering the store and typically only has one official lottery ticket machine thereby limiting the opportunity for a state to sell as many tickets as may be possible through alternative methods of one embodiment.

Buying a lottery ticket at a retail store for individuals as well as groups means a trip to a store, time to fill out a lottery ticket pick form, sometimes waiting in line, and the physical time to have a store lottery attendant take the lottery ticket pick form, process it through the lottery ticket machine and return the lottery ticket to the person, take their payment and return any change. If for example the user/player runs into traffic or the store is crowded and the cut-off time for buying a lottery ticket is near they could be prevented from playing the current game and may lose out on a jackpot winning ticket.

In the descriptions that follow the term group lotto network lottery ticket retailer module control box and lottery ticket control box are interchangeably used to describe an apparatus. In the descriptions that follow the term group lotto lottery ticket pick forms carousel and carousel are interchangeably used to describe an apparatus. In the descriptions that follow the term group lotto adapted printer module and adapted printer module are interchangeably used to describe an apparatus of one embodiment.

The group lotto website network 2100 can operate at least one group lotto network lottery ticket retailer module 2500, can increase the opportunity to purchase a lottery ticket on-line instead of in line, not require the lottery ticket purchaser to make a trip or special trip to a retail store to buy lottery tickets, saves gasoline, reduces vehicle emissions, reduces traffic, allows lottery ticket sales to take place 24 hours a day and 7 days a week, and give states an unlimited opportunity to sell lottery tickets of one embodiment.

FIG. 25 shows the group lotto website network 2100 including the at least one database 501, the internet connection devices 502, the digital OCR device 2112, group lotto application interface 2110, and lottery ticket dispensing module 2160. After the group lotto sign-in process 2210 of FIG. 22A a group lotto user/player submits a valid picture ID 2481 of FIG. 24 including the user/player driver's license 2482 the group lotto user/player submits a form of payment including a credit or debit bank card 2480. The group lotto network lottery ticket retailer module 2500 is coupled to the group lotto website network 2100 using a group lotto network lottery ticket retailer module control box 2580. The lottery ticket control box 2580 includes cabling connections and at least one digital processor. Cabling to and from the lottery ticket control box 2580 includes fiber optic cabling.

The group lotto website network 2100 uploads appropriate official lottery agency regulations and policies previously downloaded from the official lottery agency to the lottery ticket dispensing module 2160. The lottery ticket dispensing module 2160 performs a legal age to play process to clear the user/player for ordering lottery tickets. The lottery ticket dispensing module 2160 transmits the specifics for the lottery game requested by the user/player to the user/player digital device to display using the group lotto application 2120 of FIG. 21. The group lotto application 2120 of FIG. 21 also verbally announces the range of non-bonus and bonus numbers. The group lotto application 2120 of FIG. 21 is configured for receiving, processing and responding to verbal instructions and questions. The group lotto application 2120 of FIG. 21 is configured for receiving, processing and responding to verbal instructions and questions in a plurality of languages. The group lotto application 2120 of FIG. 21 through the group lotto website network 2100 is configured for receiving, processing and responding to braille messages, emails and images of braille text instructions and questions using the braille translator 2117 and to respond to the user/player in braille messages sent to a digital braille typewriter with a USB connection to an internet connection device.

The specifics for the lottery game include for example non-bonus selectable numbers for typically 5 numbers to be selected out of the non-bonus selectable numbers and a separate group of bonus selectable numbers for typically 1 number to be selected out of the bonus selectable numbers. The user/player may select a number by tapping on the number in the display or by verbally announcing the number. When the user/player makes a selection of a number the lottery ticket dispensing module 2160 darkens that number on the display and disables that number so the user/player cannot make a duplicate selection. The lottery ticket dispensing module 2160 processes a tally on the quantity of numbers selected and on the display shows how many additional numbers need to be selected. The lottery ticket dispensing module 2160 when a full game ticket selections have been filled the user/player is asked if they want to play an additional ticket. If the user/player clicks or verbally responds yes the number selection process is repeated for a new ticket. If the user/player clicks or verbally responds no, then the lottery ticket dispensing module 2160 calculates using the at least one digital processor 2114 of FIG. 21 the amount the user/player will pay for the total of tickets played and mailing expense and displays that amount and asks the user/player if they want to charge that amount on the a credit or debit bank card 2480 submitted by the user/player. If the user/player responds no then the lottery ticket dispensing module 2160 cancels the transaction. If the responds yes then the lottery ticket dispensing module 2160 continues the process to transmit the selected game and selected groups of ticket numbers selected to the lottery ticket control box 2580 of one embodiment.

An array of unmarked appropriate lottery ticket pick forms 2400 are placed in a group lotto lottery ticket pick forms carousel 2510. The carousel 2510 is coupled to the lottery ticket control box 2580; the coupling connection is not shown. The carousel 2510 is rotated using position indexed increments using a servo-motor. The carousel 2510 servo motor not shown is activated by the lottery ticket control box 2580 at least one digital processor to position appropriate lottery ticket pick forms identified from downloaded information from the group lotto network of one embodiment.

An unmarked appropriate lottery ticket pick form 2400 from the carousel 2510 is fed into a group lotto adapted printer module 2520 coupled to an official lottery ticket machine 2540. The group lotto adapted printer module 2520 is also coupled to the lottery ticket control box 2580. The adapted printer module 2520 includes a group lotto adapted printer module processor 2115. The group lotto adapted printer module processor 2115 converts the numbers selected by the group lotto group into corresponding mark-outs for the numbers displayed on the appropriate game lottery ticket pick form. The lottery ticket control box 2580 transmits the user/player selected numbers to the adapted printer module processor 2115. The lottery ticket control box 2580 can also transmit a user/player selected quick pick 2260 of FIG. 22C selection to the adapted printer module 2520 bypassing the adapted printer module 2520 since no marked appropriate game lottery ticket pick form is used. The adapted printer module 2520 prints number mark-outs accurately on the unmarked appropriate lottery ticket pick form 2400 of one embodiment.

The adapted printer module 2520 conveys a selected numbers marked appropriate lottery ticket pick form 2522 to the official lottery ticket machine 2540. The marked appropriate lottery ticket pick form 2450 enters an official lottery tick machine 2540. The official lottery tick machine 2540 processed marked appropriate lottery ticket pick form 2450 is conveyed out of the official lottery ticket machine 2540 and is deposited into a processed marked appropriate lottery ticket pick form holding tray 2585 of one embodiment.

The group lotto network lottery ticket retailer module 2500 automatically photographs 2593 using a first mounted camera 2592 the processed marked appropriate lottery ticket pick form 2450 and records the official lottery ticket machine 2540 processing date and time superimposed on the photograph. The photographic image of the processed marked appropriate lottery ticket pick form 2450 is transmitted to the lottery ticket control box 2580 and further transmitted to be recorded and stored in the at least one database 501.

The official lottery ticket machine 2540 creates a corresponding lottery game ticket 2550. The corresponding lottery game ticket 2550 is conveyed out of the official lottery ticket machine 2540 and is deposited 2552 is a tilt-able lottery game ticket tray 2556. The group lotto network lottery ticket retailer module 2500 automatically photographs 2594 using a second mounted camera 2590 the newly deposited lottery game ticket 2550. The photographic image of the newly deposited lottery game ticket 2550 is transmitted to the lottery ticket control box 2580 and further transmitted to be recorded and stored in the at least one database 501. The digital OCR device 2112 processes the photographic image for gathering of information from the corresponding lottery game ticket 2550. The corresponding lottery game ticket 2550 information includes a unique serial number, the official lottery data printed on the corresponding lottery game ticket 2550 and the numbers selected, picked and printed on the corresponding lottery game ticket 2550. This information is recorded and stored on the at least one database 501 under a user/player file of one embodiment.

The tilt-able lottery game ticket tray 2556 includes an axle connected to a solenoid motor that is coupled to the lottery ticket control box 2580. The lottery ticket control box 2580 activates the tilt-able lottery game ticket tray 2556 solenoid motor when a user/player lottery ticket order is completed. The solenoid motor rotates the connecting axle to a predetermined angle to create an incline (tilt) to the tilt-able lottery game ticket tray 2556 to cause the lottery game ticket(s) of the user/player completed order to slide into an opened envelope positioned in an envelope stuffing device 2116. The tilt-able lottery game ticket tray 2556 includes a vibration creating apparatus to insure all the lottery game ticket(s) in the tilt-able lottery game ticket tray 2556 of the user/player completed order slide into the opened envelope 2562 of one embodiment.

Lottery game ticket(s) 2558 in the opened envelope 2562 are processed in the envelope stuffing device 2116 configured to perform a process in which the envelope is sealed, an address label is imprinted with the user/player address of record downloaded from the group lotto website network 2100 using the lottery ticket control box 2580 and affixed to the sealed envelope. A sealed addressed envelope 2564 is also marked with a notice to return to sender if undeliverable and a certified mailing label is printed and affixed to the sealed envelope. The lottery ticket control box 2580 transmits a signal to the lottery ticket dispensing module 2160 when the addressed sealed envelope process is complete and the lottery ticket dispensing module 2160 processes the payment charge to the user/player credit or debit bank card 2480. A sealed addressed envelope drops into a receiver 2566. Sealed addressed envelopes from a sealed addressed envelope receiver 2568 are conveyed to a mail pickup point 2570. The mail pickup point 2460 is where sealed addressed envelopes can be picked up by the postal service or a private document delivery service for delivery to the user/player of one embodiment.

### Lost and Stolen Lottery Ticket Protection

The group lotto website network 2100 process includes maintaining the user/player issued lottery game ticket(s) 2550 in the form of photographs and the unique serial number and the official lottery data printed on the corresponding lottery game ticket 2550. The group lotto website network 2100 process provides lost and stolen lottery ticket protection for the user/player. The corresponding lottery game ticket 2550 information includes a unique serial number, the official lottery data printed on the corresponding lottery game ticket 2550 and the numbers selected, picked and printed on the corresponding lottery game ticket 2550. This information is recorded and stored on the at least one database 501 under a user/player file of one embodiment.

A user/player can report a stolen ticket for example from the mailing of the tickets. The group lotto website network 2100 automatically reports to the appropriate lottery and scratch-off game agency the stolen ticket information. The appropriate lottery and scratch-off game agency can flag their pay-off methods not to pay on the stolen tickets. Any lottery or scratch-off outlet when processing a ticket will see a do not pay stolen ticket notice displayed on their official lottery ticket machine 2540 and instructions to call the police to report that the thief is at their place of business. The recovered ticket is sent to the appropriate lottery and scratch-off game agency who will notify the rightful owner as initially reported by the group lotto website network 2100 and the rightful user/player can claim their ticket and winnings of one embodiment.

### Group Lotto Network Scratch-Off Ticket Retailer Module

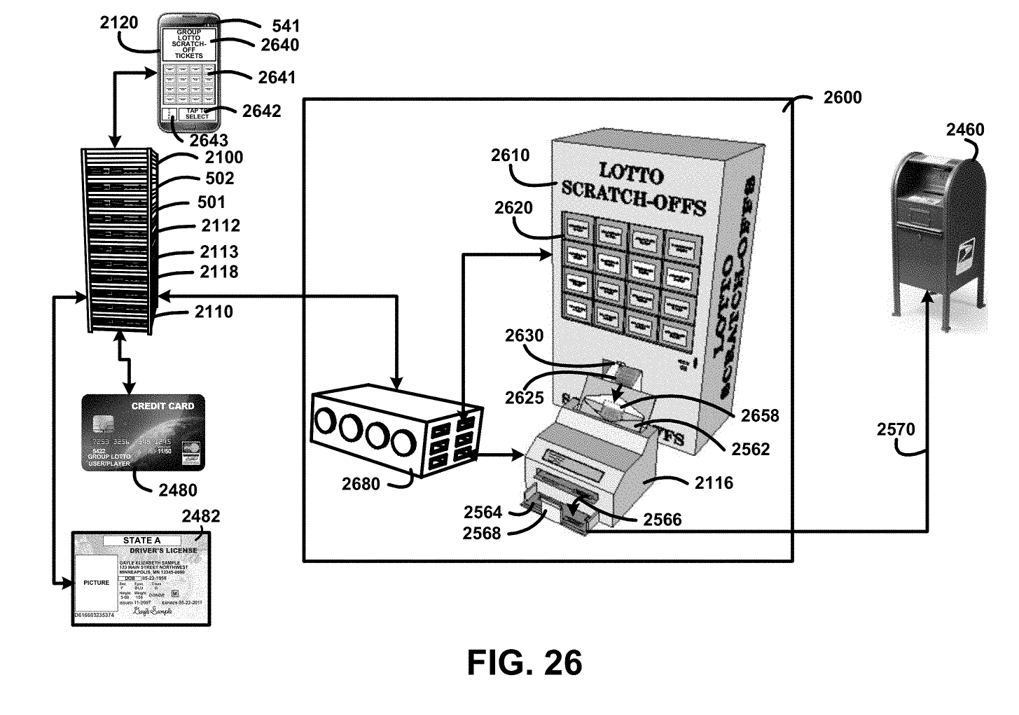

FIG. 26 shows for illustrative purposes only an example of a group lotto network scratch-off ticket retailer module of one embodiment. FIG. 26 shows a group lotto network scratch-off ticket retailer module 2600. The group lotto website network 2100 can operate at least one group lotto network scratch-off ticket retailer module 2600, can increase the opportunity to purchase a scratch-off ticket on-line instead of in line, not require the scratch-off ticket purchaser to make a trip or special trip to a retail store to buy scratch-off tickets, saves gasoline, reduces vehicle emissions, reduces traffic, allows scratch-off ticket sales to take place 24 hours a day and 7 days a week, and give states an unlimited opportunity to sell scratch-off tickets of one embodiment.

In the descriptions that follow the term group lotto network scratch-off ticket retailer module control box and scratch-off ticket control box are interchangeably used to describe an apparatus. The group lotto network scratch-off ticket retailer module 2600 is coupled to the group lotto website network 2100 with the at least one database 501, at least one internet connection device 502, digital OCR device 2112, the digital audible text reader 2113, group lotto application interface 2110 used for interactive processes using a group lotto application 2120 installed on user/player digital devices, and scratch-off ticket dispensing module 2118. The user/player using a user digital devices 540 of FIG. 5 including smart phones 541 with the group lotto application 2120 after a successful group lotto sign-in process 2210 of FIG. 22A submits a valid picture ID 2481 of FIG. 24 for example a driver's license 2482 or an identification card 2483 of FIG. 24 issued by the state to provide proof of legal age to purchase a scratch-off ticket. The group lotto user/player submits a form of payment including a credit or debit bank card 2480 to pay for buying a scratch-off ticket(s) and the mailing cost to send the scratch-off ticket(s) to the user/player of one embodiment.

The group lotto network group lotto network scratch-off ticket retailer module 2600 is coupled to the group lotto website network 2100 using a group lotto network scratch-off ticket retailer module control box 2680. The scratch-off ticket control box 2680 includes cabling connections and at least one digital processor. Cabling to and from the scratch-off ticket control box 2680 includes fiber optic cabling of one embodiment.

The group lotto website network 2100 uploads appropriate official lottery agency regulations and policies previously downloaded from the official lottery agency to the scratch-off ticket dispensing module 2118. The scratch-off ticket dispensing module 2118 performs a legal age to play process to clear the user/player for ordering scratch-off tickets.

The scratch-off ticket dispensing module 2118 transmits the specifics for the scratch-off games currently available 2641 to the user/player digital device to display using the group lotto application 2120. The group lotto application 2120 also verbally announces the list of scratch-off games currently available 2641. The group lotto application 2120 is configured for receiving, processing and responding to verbal instructions and questions. The group lotto application 2120 is configured for receiving, processing and responding to verbal instructions and questions in a plurality of languages. The group lotto application 2120 through the group lotto website network 2100 is configured for receiving, processing and responding to braille messages, emails and images of braille text instructions and questions using the braille translator 2117 and to respond to the user/player in braille messages sent to a digital braille typewriter with a USB connection to an internet connection device of one embodiment.

The specifics for the scratch-off game include for example prizes offered and a symbol or amount representing each prize that needs to be revealed when the user/player scratches off the covering mask. The scratch-off ticket dispensing module 2118 transmits a list and image of each scratch-off game available to be selected to the user digital devices 540 of FIG. 5 for example the smart phone 541 of one embodiment.

The group lotto application 2120 displays a heading group lotto scratch-off tickets 2640 and beneath a list and image of each scratch-off game available 2641 on the smart phone screen display with the instruction tap to select 2642. The user/player may select a scratch-off game by tapping on the image or by verbally announcing the name of the scratch-off game. When the user/player makes a selection of a scratch-off ticket the scratch-off ticket dispensing module 2118 records the selection in an order file. When the user/player taps or announces done 2643 the scratch-off ticket dispensing module 2118 closes the order file and processes a tally on the quantity of scratch-off tickets selected of one embodiment.

The scratch-off ticket dispensing module 2118 calculates using the at least one digital processor 2114 of FIG. 21 the amount the user/player will pay for the total of tickets played and mailing expense and displays that amount and asks the user/player if they want to charge that amount on the a credit or debit bank card 2480 submitted by the user/player. If the user/player responds no then the scratch-off ticket dispensing module 2118 cancels the order transaction. If the user/player responds yes then the scratch-off ticket dispensing module 2118 continues the process to transmit the selected scratch-off tickets to the scratch-off ticket control box 2680. The scratch-off ticket control box 2680 is coupled to an official scratch-off ticket machine 2610. The scratch-off ticket control box 2680 transmits the selected scratch-off tickets to the official scratch-off ticket machine 2610 which begins a process to activate selected scratch-off game ticket vending racks 2620 and deposit the selected scratch-off ticket(s) into a scratch-off ticket receiving tray 2625 of one embodiment.

The group lotto network group lotto network scratch-off ticket retailer module 2600 automatically photographs using a scratch-off ticket camera 2630 and records the official scratch-off ticket machine 2610 processing date and time superimposed on the photograph. The photographic image of the scratch-off ticket is transmitted to the scratch-off ticket control box 2680 and further transmitted to be recorded and stored in the at least one database 501. The digital OCR device 2112 processes the photographic images of the scratch-off tickets for gathering of information from the scratch-off ticket 2658. The scratch-off ticket 2658 information includes a unique serial number, the official lottery data printed on the scratch-off ticket 2658. This information is recorded and stored on the at least one database 501 under a user/player file of one embodiment.

The scratch-off ticket receiving tray 2625 drops a plate at the bottom edge of the tray, not shown, to prevent the dropped scratch-off tickets from sliding off prematurely. When all the scratch-off tickets in an order have accumulated in the tray the scratch-off ticket control box 2680 temporarily lowers the plate allowing the accumulated scratch-off tickets of the completed order to slide into an opened envelope 2562 positioned in an envelope stuffing device 2116 of one embodiment.

The scratch-off game ticket(s) 2658 in the opened envelope 2562 are processed in the envelope stuffing device 2116 configured to perform a process in which the envelope is sealed, an address label is imprinted with the user/player address of record downloaded from the group lotto website network 2100 using the scratch-off ticket control box 2680 and affixed to the sealed envelope. A sealed addressed envelope 2564 is also marked with a notice to return to sender if undeliverable and a certified mailing label is printed and affixed to the sealed envelope. When the completed order is enclosed in the sealed envelope the scratch-off ticket control box 2680 transmits a signal to the scratch-off ticket dispensing module 2118 that processes the payment charge to the user/player credit or debit bank card 2480. A sealed addressed envelope drops into a receiver 2566. Sealed addressed envelopes from a sealed addressed envelope receiver 2568 are conveyed to a mail pickup point 2570. The mail pickup point 2460 is where sealed addressed envelopes can be picked up by the postal service or a private document delivery service for delivery to the user/player of one embodiment.

### Lost and Stolen Scratch-Off Ticket Protection

The group lotto website network 2100 process includes maintaining the user/player issued scratch-off game ticket(s) 2658 in the form of photographs and the unique serial number and the official lottery data printed on the scratch-off game ticket 2658. The group lotto website network 2100 process provides lost and stolen scratch-off ticket protection for the user/player. The scratch-off game ticket 2658 information includes a unique serial number, the official lottery data printed on the scratch-off game ticket 2658. This information is recorded and stored on the at least one database 501 under a user/player file of one embodiment.

A user/player can report a stolen ticket for example from the mailing of the tickets. The group lotto website network 2100 automatically reports to the appropriate lottery and scratch-off game agency the stolen ticket information. The appropriate lottery and scratch-off game agency can flag their pay-off methods not to pay on the stolen tickets. Any lottery or scratch-off outlet when processing a ticket will see a do not pay stolen ticket notice displayed on their official scratch-off ticket machine 2610 and instructions to call the police to report that the thief is at their place of business. The recovered ticket is sent to the appropriate lottery and scratch-off game agency who will notify the rightful owner as initially reported by the group lotto website network 2100 and the rightful user/player can claim their ticket and winnings of one embodiment.

### Group Lotto Network Lottery Ticket Retailer for an Out of Town Resident Process

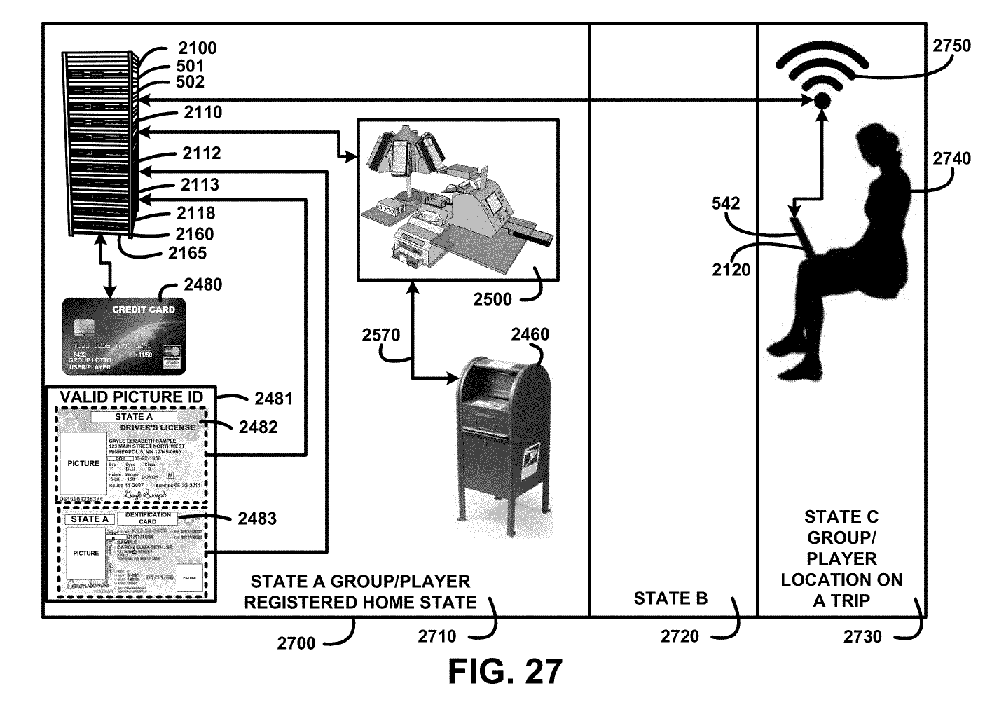

FIG. 27 shows for illustrative purposes only an example of a group lotto network lottery ticket retailer for an out of town resident process of one embodiment. FIG. 27 shows the group lotto website network 2100 including at least one database 501, at least one internet connection device 502, group lotto application interface 2110, digital OCR device 2112, digital audible text reader 2113, scratch-off ticket dispensing module 2118, GPS location module 2165, and lottery ticket dispensing module 2160. FIG. 27 also shows a group lotto network lottery ticket retailer for an out of town resident process 2700. The group lotto network lottery ticket retailer for an out of town resident process 2700 allows an user/player resident out of town 2740 of state A 2710 to play for example the state A 2710 lottery draw game while away on a trip. In this example the user/player resident out of town 2740 of state A 2710 is on the other side of state B 2720 and temporarily in state C 2730 of one embodiment.

FIG. 27 shows the user/player resident out of town 2740 using one of the user digital devices 540 of FIG. 5 for example the laptop computers 542. The user/player resident out of town 2740 has installed the group lotto application 2120 and has successfully completed the group lotto sign-in process 2210 of FIG. 22A using a WIFI connection 2750 to connect to the group lotto website network 2100. The group lotto website network 2100 has check the GPS location module 2165 and determined the user/player resident out of town 2740 is not in state A but is a current resident of state A and state A group/player registered home state 2710 is of record and verifiable through the valid picture ID 2481 of FIG. 24 for example a driver's license 2482 or an identification card 2483 issued by state A 2710 of one embodiment.

The user/player resident out of town 2740 cannot play the state A 2710 lottery at a state C 2730 lottery retailer because it is not offered. The user/player resident out of town 2740 can order a state A draw game lottery ticket on-line and have it mailed or delivered to their address of record in state A 2710. No lottery ticket will be crossing state borders therefore the lottery ticket should not violate interstate gambling regulations. The user/player resident out of town 2740 will not be in possession of the lottery ticket until they are within state A 2710 and would have to claim any winnings in state A 2710 of one embodiment.

The user/player resident out of town 2740 submits a valid picture ID 2481 for example a driver's license 2482 or an identification card 2483 issued by the state to provide proof of legal age to purchase a lottery ticket. The user/player resident out of town 2740 submits a form of payment including a credit or debit bank card 2480 to pay for buying the lottery ticket(s) and mailing or delivery to their address of record in state A 2710 of the lottery ticket(s) order.

The user/player resident out of town 2740 proceeds to follow the process of the group lotto network lottery ticket retailer module 2500 to complete their purchase of the state A 2710 lottery ticket(s). The state A 2710 lottery ticket(s) in a sealed addressed envelope is conveyed to a mail pickup point 2570. The mail pickup point 2460 will process the mailing or delivery of the address of record in state A 2710. The user/player resident out of town 2740 can also elect to pay the state A 2710 scratch-off games by proceeding to follow the process of the group lotto network scratch-off ticket retailer module 2600 of one embodiment.

### Group Lotto Network Lottery Ticket and Scratch-Off Retailer for a Disabled Resident Module

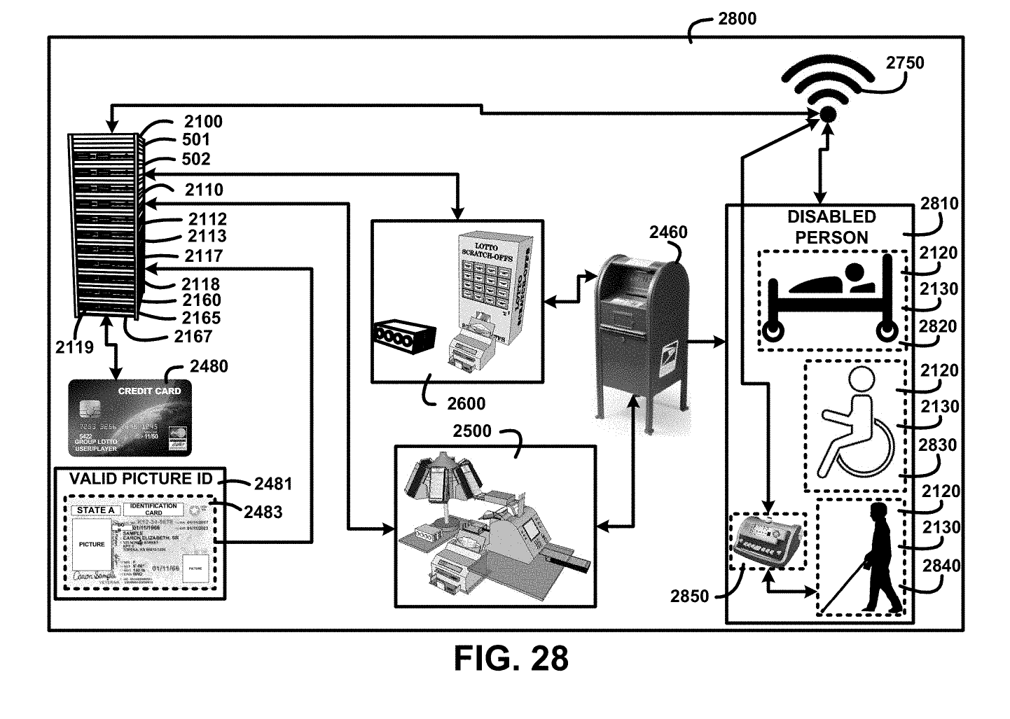

FIG. 28 shows for illustrative purposes only an example of a group lotto network lottery ticket and scratch-off retailer for a disabled resident module of one embodiment. In the descriptions that follow the term group lotto network lottery ticket and scratch-off retailer for a disabled resident module and disabled resident module are interchangeably used to describe an apparatus and process. FIG. 28 shows the group lotto website network 2100 including at least one database 501, at least one internet connection device 502, group lotto application interface 2110, digital OCR device 2112, digital audible text reader 2113, scratch-off ticket dispensing module 2118, GPS location module 2165, lottery ticket dispensing module 2160, braille translator 2117, and language translator module 2119 of one embodiment.

FIG. 28 also shows a group lotto network lottery ticket and scratch-off retailer for a disabled resident module 2800. The disabled resident module 2800 allows compliance with the Americans with Disabilities Act (ADA) to be expanded in the retailing of lottery and scratch-off tickets and play. Many states use physical locations for example convenience stores, grocery stores and other types of retail locations to have retailers sell the lottery and scratch-off game tickets. Able-bodied persons wishing to play lottery and scratch-off games may not find this a difficulty. A disabled person 2810 may find this an impossible obstacle to have the opportunity to play lottery and scratch-off games.

A disabled person 2810 may be bed ridden 2820 and simply cannot travel to for example convenience stores. A disabled person 2810 may be hospitalized for a period and cannot leave the hospital to visit a retail location to buy a lottery ticket or scratch-off. A disabled person 2810 may require a wheelchair 2830 or other accommodation due to mobility conditions and making a trip to a retail location can require costly special transportation. Some recent scratch-off vending machines that do not have an attendant are too high for a disabled person 2810 in a wheelchair to reach all or some of the selectable scratch-off game selection buttons. Some recent unmanned lottery ticket sales machines are not designed for wheelchair access, generally a standard even in restaurants to provide clear space for the disabled person 2810 to maneuver the wheelchair under for example a shelf or table. A disabled person 2810 may be blind 2840 or have vision conditions that do allow them to read scratch-off tickets in a retail display case or on an unattended vending machine. A disabled person 2810 may not be able to see or read a lottery ticket pick form or fill it out clearly to be able to play at all. Many blind 2840 disabled persons use braille to read common signs they encounter for example the required braille translations of elevator floors and operating buttons. In general most lottery and scratch-off games and gaming machines are designed without any accommodation for a disabled person 2810. States are required to enforce compliance with the ADA throughout their region including state buildings and offices and in these cases state run enterprises.

The disabled resident module 2800 of the group lotto website network 2100 is configured to expand the opportunity of playing lottery and scratch-off games to a disabled person and others. This expanded opportunity further extends to non-disabled persons who because of language barriers do not understand how to play or may be discriminated against because of the language barrier. Another group of persons who may not be considered physical disabled are seniors and elderly persons who may because of age cannot obtain a driver's license. For non-driving persons a trip to a retail location selling lottery and scratch-off game is difficult. Some of the seniors and elderly who may live in inner-city neighborhoods have a fear of street violence. Crime statistics and news reports often point to the reality that seniors and the elderly are easy targets of street violence.

The disabled resident module 2800 can remove many of the obstacles confronting disabled persons, those with language barriers, non-driving persons and those seniors and elderly with real or perceived fear of potential violence and will open the opportunity to participate in the lottery and scratch-off games. This will further benefit the state lottery and scratch-off gaming by increasing the number of persons that will have an opportunity to play and further any efforts of the state to comply with the Americans with Disabilities Act and reduce discriminatory barriers.

Many of these same groups including the bed ridden 2820, require a wheelchair 2830, and are blind 2840 or have vision conditions use digital devices including smart phones 541 of FIG. 5, laptop computers 542 of FIG. 5, desk top computers 543 of FIG. 5, and tablets 544 of FIG. 5 to communicate with friends, family, and doctors. For some it is a source of entertainment, news and other forms of staying in contact with the outside world they may not be able to visit often. Those same common digital devices and be transitioned into group lotto user/player digital devices 2130 by the installation of the group lotto application 2120. The disabled resident module 2800 through the group lotto website network 2100 can provide those impacted with disabilities and other obstacles can have the opportunity to play lottery and scratch-off games on-line without having to visit a retail location.

These affected groups can play lottery draw games using the group lotto network lottery ticket retailer module 2500 and can play scratch-off games using the group lotto network scratch-off ticket retailer module 2600. Those persons with language barriers can communicate with the group lotto website network 2100 using the language translator module 2119 in their native language with the group lotto website network 2100 and have game instructions and each step in a game play process explained verbally and in translated displayed text in their native language. A disabled person 2810 who is blind 2840 or have vision conditions can communicate with the group lotto website network 2100 verbally or through the use of a digital braille typewriter with a USB connection to an internet connection device 2850. The group lotto website network 2100 using the braille translator 2117 can receive, translate, and respond in braille to the digital braille typewriter with a USB connection to an internet connection device 2850.

These affected groups including a disabled person 2810 using one of the group lotto user/player digital devices 2130 with the group lotto application 2120 installed will complete the group lotto sign-in process 2210 of FIG. 22A using a WIFI connection 2750 to connect to the group lotto website network 2100. These user/players will submit a form of payment including a credit or debit bank card 2480 to pay for their lottery and/or scratch-off tickets ordered and mailing of their order. These user/players will submit a valid picture ID 2481 for example an identification card 2483 issued by the state to provide proof of legal age to purchase a lottery ticket and they can participate in playing lottery and scratch-off games.

### Gaming and Gambling Addiction Monitoring

A concern of gaming and gambling addiction is valid for all persons playing lottery and scratch-off games. The group lotto website network 2100 includes a gaming and gambling addiction monitoring module 2167. The gaming and gambling addiction monitoring module 2167 asks each group lotto user/player periodically how much money they are budgeting for lottery and scratch-off game play per an increment of time for example per week and per month. The gaming and gambling addiction monitoring module 2167 displays a notice that gaming and gambling can become addictive and that it is the responsibility of each group lotto user/player to determine a limit on how much they can afford to risk for lottery and scratch-off gaming play since winning any amount is not guaranteed. The group lotto user/player can enter an amount and for what period of time. The gaming and gambling addiction monitoring module 2167 tracks the lottery and scratch-off gaming play using the orders placed for tickets. When a group lotto user/player signs-in to the group lotto website network 2100 the gaming and gambling addiction monitoring module 2167 displays the budget amount the user/player entered, the increment of time and the current balance remaining for that increment of time. The group lotto user/player can using the gaming and gambling addiction monitoring module 2167 remain aware of what they are spending and remind the user/player of the balance remaining of the amount they have budgeted and play responsibly of one embodiment.

The foregoing has described the principles, embodiments and modes of operation of the embodiments. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the embodiments as defined by the following claims.

What is claimed is:

1. A method, comprising:
creating an online marketing lottery scratch-off method for at least one marketing opportunity for companies;
creating an online marketing lottery scratch-off website;
displaying online virtual scratch-off tickets to offer prizes to a user for gathering user marketing information;
recording user marketing information in an online marketing lottery scratch-off website database; and
analyzing online marketing lottery scratch-off method database customer data collected for targeted purposes.

2. The method of claim 1, wherein the gathering user marketing information includes a marketing series of questions including marital status, income level and how many vacations the user takes per year and a user location using a mobile application GPS recognition.

3. The method of claim 1, wherein the displaying online virtual scratch-off tickets to offer prizes to a user includes online marketing lottery scratch-off prizes including vacation online marketing lottery scratch-off prizes including Hawaiian vacations, pickup truck online marketing lottery scratch-off prizes, car online marketing lottery scratch-off prizes, boat online marketing lottery scratch-off prizes, cruise vacation online marketing lottery scratch-off prizes and time-share vacation online marketing lottery scratch-off prizes.

4. The method of claim 1, wherein the displaying online virtual scratch-off tickets to offer prizes to a user includes online marketing lottery scratch-off prizes including vehicle prizes including a pickup truck and including a car and including a boat.

5. The method of claim 1, wherein the gathering user marketing information includes integrating marketing company advertising formulas to analyze targeted customer data in an online marketing lottery scratch-off method database to capture more potential buyers.

6. The method of claim 1, wherein the displaying online virtual scratch-off tickets to offer prizes to a user includes other prizes including online marketing lottery scratch-off prizes including vacation package discounts, souvenirs, hats, travel bags, consumer products, and services.

7. The method of claim 1, wherein the displaying online virtual scratch-off tickets to offer prizes to a user includes other prizes including time-share vacation marketing scratch-off prizes including airfare, free hotel nights, meals, day events including parasailing, jet skiing, tours and gifts.

8. The method of claim 1, wherein the analyzing online marketing lottery scratch-off method database customer data collected for targeted purposes includes to analyze targeted customer data for identifying potential customers for example vacation ownership companies and time share real estate properties.

9. The method of claim 1, wherein the creating an online marketing lottery scratch-off method for at least one marketing opportunity for companies including movie studios can offer prizes including free movie tickets to new movie releases to reduce marketing, advertising and publicity cost for each film release.

10. The method of claim 1, wherein the creating an online marketing lottery scratch-off website includes a network structure including at least one digital server, at least one database, at least one internet connection device , at least one fingerprint ID device, at least one retina recognition device, and at least one facial recognition device.

11. An apparatus, comprising:
an online marketing lottery scratch-off website includes a network structure including at least one digital server, at least one database, at least one internet connection device , at least one fingerprint ID device, at least one retina recognition device, and at least one facial recognition device;
wherein the at least one internet connection device is used for accessing the network structure using user digital devices;
wherein the at least one database is for recording user marketing information;
wherein the at least one digital server is used for analyzing online marketing lottery scratch-off method database customer data collected for targeted purposes; and
wherein the online marketing lottery scratch-off website is used for displaying online virtual scratch-off tickets to offer prizes to a user for gathering user marketing information.

12. The apparatus of claim 11, further comprising user digital devices including smart phones, laptop computers, desk top computers and tablets.

13. The apparatus of claim 11, further comprising recording user marketing information includes a marketing series of questions including marital status, income level and how many vacations the user takes per year and a user location using a mobile application GPS recognition.

14. The apparatus of claim 11, further comprising analyzing online marketing lottery scratch-off method database customer data collected for targeted purposes including to analyze targeted customer data for identifying potential customers for example vacation ownership companies and time share real estate properties

15. The apparatus of claim 11, further comprising a network structure is used for integrating marketing company advertising formulas to analyze targeted user marketing information data recorded in the online marketing lottery scratch-off website at least one database to capture more potential buyers.

16. A method, comprising:
creating a group lotto website network including a group lotto secure sign-in process, a group lotto lottery number selection process, a group lotto lottery ticket process, an automatic lottery ticket pick form process, a group lotto network lottery ticket retailer module, a group lotto network scratch-off ticket retailer module, a group lotto network lottery ticket retailer for an out of town resident process, and a group lotto network lottery ticket and scratch-off retailer for a disabled resident module;
creating a group lotto application for connecting to the group lotto website network using group lotto user/player digital devices;
wherein the a group lotto lottery ticket process allows a group of user/players to play lottery and scratch-off ticket games jointly;
wherein the automatic lottery ticket pick form process marks the group of user/players lottery ticket pick forms with selected numbers; and
wherein the group lotto website network allows lottery and user/players to purchase lottery and scratch-off tickets online using the group lotto application without going to a lottery and scratch-off retail location.

17. The apparatus of claim 16, wherein the group lotto network lottery ticket retailer module allows a user/player and a group of user/players to play lottery draw games online using the group lotto application without going to a lottery and scratch-off retail location.

18. The apparatus of claim 16, wherein the group lotto network scratch-off ticket retailer module allows a user/player and a group of user/players to play scratch-off games online using the group lotto application without going to a lottery and scratch-off retail location.

19. The apparatus of claim 16, wherein the group lotto network lottery ticket retailer for an out of town resident process allows a user/player to purchase their home state lottery and scratch-off tickets online using the group lotto application while out of their home state without going to a home state lottery and scratch-off retail location.

20. The apparatus of claim 16, wherein the group lotto network lottery ticket and scratch-off retailer for a disabled resident module allows a disabled person user/player to play lottery and scratch-off games online using the group lotto application without going to a lottery and scratch-off retail location.
